(19) United States
(12) Patent Application Publication
(10) Pub. No.: US 2020/0004125 A1
(43) Pub. Date: Jan. 2, 2020

(54) PROJECTION LENS AND PROJECTION APPARATUS

(71) Applicant: SONY CORPORATION, TOKYO (JP)

(72) Inventor: HIDEAKI OKANO, AICHI (JP)

(21) Appl. No.: 16/487,262

(22) PCT Filed: Feb. 19, 2018
(86) PCT No.: PCT/JP2018/005722

§ 371 Date: Aug. 20, 2019

(30) Foreign Application Priority Data
Mar. 22, 2017 (JP) 2017-056104

(51) Int. Cl. G03B 21/20; G02B 9/64; G02B 13/18

(52) U.S. Cl. CPC G03B 21/208; G02B 13/18; G02B 9/64

(57) ABSTRACT

A projection lens of the present disclosure includes, in order from projection side toward side of an image to be projected: a first lens group including a predetermined negative lens including a material having a linear expansion coefficient equal to or more than 3*10⁻⁵/° C. and having negative refractive power as a whole; an aperture; and a second lens group including a predetermined positive lens including a material having a linear expansion coefficient equal to or more than 3*10⁻⁵/° C. and having positive refractive power as a whole.

### TECHNICAL FIELD

The present disclosure relates to a projection lens that projects an image, and a projection apparatus.

### BACKGROUND ART

There is a projector that enlarges and projects an image to be projected, which is formed on a display device such as a liquid crystal panel or a digital mirror device, onto a screen using a projection lens.

### CITATION LIST

### Patent Literature

PTL 1: Japanese Unexamined Patent Application Publication No. 2003-121736

PTL 2: Japanese Unexamined Patent Application Publication No. 2004-184932

### SUMMARY OF THE INVENTION

In recent years, there has been an increasing need for a compact and lightweight projection apparatus, and it is also desired to reduce the size of a projection lens to be mounted on the projection apparatus.

It is desirable to provide a projection lens having high optical performance as well as superior mass productivity, and a projection apparatus mounted with such a projection lens.

A first projection lens according to an embodiment of the present disclosure includes, in order from projection side toward side of an image to be projected: a first lens group including a predetermined negative lens including a material having a linear expansion coefficient equal to or more than 3*10⁻⁵/° C. and having negative refractive power as a whole; an aperture; and a second lens group including a predetermined positive lens including a material having a linear expansion coefficient equal to or more than 3*10⁻⁵/° C. and having positive refractive power as a whole.

A first projection apparatus according to an embodiment of the present disclosure includes a display device that displays an image to be projected, and a projection lens that projects the image to be projected, in which the projection lens is configured by the first projection lens according to the embodiment of the present disclosure.

In the first projection lens or the first projection apparatus according to the embodiment of the present disclosure has a two-group configuration as a whole with the aperture being interposed therebetween, thus achieving optimization of configurations of respective lens groups.

A second projection lens according to an embodiment of the present disclosure includes, in order from projection side toward side of an image to be projected: a first lens group having negative refractive power as a whole; an aperture; and a second lens group having positive refractive power as a whole, in which the first lens group includes, in order from the projection side toward the side of the image to be projected, a first lens having positive refractive power, a second lens having negative refractive power, and a third lens having positive or negative refractive power, and in which the second lens group includes, in order from the projection side toward the side of the image to be projected, a fourth lens having positive refractive power, a cemented lens including a fifth lens and a sixth lens and having negative refractive power as a whole, and a seventh lens having positive refractive power.

A second projection apparatus according to an embodiment of the present disclosure includes a display device that displays an image to be projected and a projection lens that projects the image to be projected, in which the projection lens is configured by the second projection lens according to the embodiment of the present disclosure.

In the second projection lens or the second projection apparatus according to the embodiment of the present disclosure has a two-group configuration as a whole with the aperture being interposed therebetween, thus achieving optimization of configurations of respective lens groups.

According to the first or second projection lens or the first or second projection apparatus according to the embodiment of the present disclosure, the two-group configuration is adopted with the aperture being interposed therebetween, thus intending to achieve optimization of the configurations of the respective lens groups. This makes it possible to achieve high optical performance as well as performance superior in mass productivity.

It is to be noted that the effects described herein are not necessarily limited, and may be any of the effects described in the present disclosure.

### BRIEF DESCRIPTION OF THE DRAWINGS

FIG. 1 is a lens cross-sectional view of a first configuration example of a projection lens according to an embodiment of the present disclosure.

FIG. 2 is a lens cross-sectional view of a second configuration example of the projection lens.

FIG. 3 is a lens cross-sectional view of a third configuration example of the projection lens.

FIG. 4 is a lens cross-sectional view of a fourth configuration example of the projection lens.

FIG. 5 is a lens cross-sectional view of a fifth configuration example of the projection lens.

FIG. 6 is a lens cross-sectional view of a sixth configuration example of the projection lens.

FIG. 7 is a lens cross-sectional view of a seventh configuration example of the projection lens.

FIG. 8 is a lens cross-sectional view of an eighth configuration example of the projection lens.

FIG. 9 is a lens cross-sectional view of a ninth configuration example of the projection lens.

FIG. 10 is a lens cross-sectional view of a tenth configuration example of the projection lens.

FIG. 11 is a lens cross-sectional view of an eleventh configuration example of the projection lens.

FIG. 12 is a lens cross-sectional view of a twelfth configuration example of the projection lens.

FIG. 13 is an aberration diagram illustrating various aberrations of a projection lens according to Numerical Working Example 1 in which specific numerical values are applied to the projection lens illustrated in FIG. 1.

FIG. 14 is an aberration diagram illustrating various aberrations of a projection lens according to Numerical Working Example 2 in which specific numerical values are applied to the projection lens illustrated in FIG. 2.

FIG. 15 is an aberration diagram illustrating various aberrations of a projection lens according to Numerical Working Example 3 in which specific numerical values are applied to the projection lens illustrated in FIG. 3.

FIG. 16 is an aberration diagram illustrating various aberrations of a projection lens according to Numerical Working Example 4 in which specific numerical values are applied to the projection lens illustrated in FIG. 4.

FIG. 17 is an aberration diagram illustrating various aberrations of a projection lens according to Numerical Working Example 5 in which specific numerical values are applied to the projection lens illustrated in FIG. 5.

FIG. 18 is an aberration diagram illustrating various aberrations of a projection lens according to Numerical Working Example 6 in which specific numerical values are applied to the projection lens illustrated in FIG. 6.

FIG. 19 is an aberration diagram illustrating various aberrations of a projection lens according to Numerical Working Example 7 in which specific numerical values are applied to the projection lens illustrated in FIG. 7.

FIG. 20 is an aberration diagram illustrating various aberrations of a projection lens according to Numerical Working Example 8 in which specific numerical values are applied to the projection lens illustrated in FIG. 8.

FIG. 21 is an aberration diagram illustrating various aberrations of a projection lens according to Numerical Working Example 9 in which specific numerical values are applied to the projection lens illustrated in FIG. 9.

FIG. 22 is an aberration diagram illustrating various aberrations of a projection lens according to Numerical Working Example 10 in which specific numerical values are applied to the projection lens illustrated in FIG. 10.

FIG. 23 is an aberration diagram illustrating various aberrations of a projection lens according to Numerical Working Example 11 in which specific numerical values are applied to the projection lens illustrated in FIG. 11.

FIG. 24 is an aberration diagram illustrating various aberrations of a projection lens according to Numerical Working Example 12 in which specific numerical values are applied to the projection lens illustrated in FIG. 12.

FIG. 25 is a block diagram illustrating a configuration example of a projection apparatus.

### MODES FOR CARRYING OUT THE INVENTION

In the following, embodiments of the present disclosure are described in detail with reference to the drawings. It is to be noted that the description is given in the following order.

### 0. Comparative Example

### 1. Basic Configuration of Lenses

### 2. Workings and Effects

### 3. Numerical Working Examples of Lenses

### 4. Other Embodiments

### 0. COMPARATIVE EXAMPLE

In recent years, there has been an increasing need for a compact and lightweight projection apparatus, and it is also desired to reduce the size of a projection lens to be mounted on the projection apparatus. In addition, display devices such as liquid crystal panels and digital mirror devices also increasingly have higher pixels and higher definition, which leads to a situation where optical performance is required to be improved while promoting the size reduction, so that aspherical surfaces are generally used. At the same time, however, there is a high demand for suppressing manufacturing costs.

In order to suppress the manufacturing costs, it is common to use, for a lens, an organic material (plastics) having a linear expansion coefficient equal to or more than 3*10⁻⁵. In such a case, an issue arises where focusing characteristics vary due to a temperature change in a use environment. As a result, when the temperature change occurs, favorable focus characteristics are unlikely to be obtained.

In recent years, size reduction and higher definition of display devices have progressed also in compact projection apparatuses, which increases the number of compact projection apparatuses each having a display capability similar to that of a large projection apparatus of an installation type. Accordingly, high lens performance corresponding to such a high-definition display device is also required for a projection lens to be mounted.

Further, depending on use application of the projection apparatus, an image is viewed in the vicinity of the horizontal end or the vertical end of a projection screen, which leads to a situation where various aberrations influencing peripheral resolution performance, such as distortion aberration, field curvature, and chromatic aberration of magnification are required to be favorably corrected.

In addition, a design should be made in consideration of a heat source such as a light source disposed in the vicinity of the projection lens and of the temperature change of the use environment so as not to cause a change in resolution characteristics during use.

In order to satisfy such requirements as a compact and high-performance projection lens, it is necessary to employ a lens configuration of six or more lenses and to use glass as a lens material.

A projection lens described in PTL 1 (Japanese Unexamined Patent Application Publication No. 2003-121736) has a seven-lens configuration, and is favorably corrected as for spherical aberration and axial chromatic aberration. However, there is a possibility that peripheral resolution may be influenced due to occurrence of field curvature. In addition, due to some distortion aberration remaining, there is a possibility that, when an error occurs in assembly, the distortion aberration may be conspicuous when visually recognized in the vicinity of the horizontal end or the vertical end of the projection screen. In addition, all of lenses each include a material having a linear expansion coefficient less than 3*10⁻⁵/° C., thus leading to a concern that manufacturing costs may increase, although the lenses have strong resistance to environmental temperature change and change in the sense of resolution caused by focus variation.

The projection lens described in PTL 2 (Japanese Unexamined Patent Application Publication No. 2004-184932) has a six-lens configuration, and spherical aberration is corrected favorably as with the projection lens of PTL 1. In addition, field curvature and distortion aberration are corrected favorably, and a resolution performance of visual appearance around a screen is considered to be relatively favorable. Although the axial chromatic aberration is considered to be corrected relatively favorably, the aberration correction is insufficient depending on an output wavelength of a light source to be used. In addition, the correction of chromatic aberration of magnification is insufficient, leading to a possibility that a color shift may be conspicuous when visually recognized in the vicinity of the horizontal end and the vertical end of the screen. In addition, also with respect to the lens of PTL 2, all of the lenses each include a material having a linear expansion coefficient less than 3*10⁻⁵/° C. as with the projection lens described in PTL 1, thus leading to a concern that manufacturing costs may increase, although the lenses have strong resistance to environmental temperature change and change in the sense of resolution caused by focus variation.

It is therefore desired to develop a projection lens having a favorable optical performance corresponding to a high-pixel display device, in particular, a compact projection lens having an optical performance with an emphasized peripheral performance and being superior in cost and mass productivity as well as in assemblability.

### 1. BASIC CONFIGURATION OF LENSES

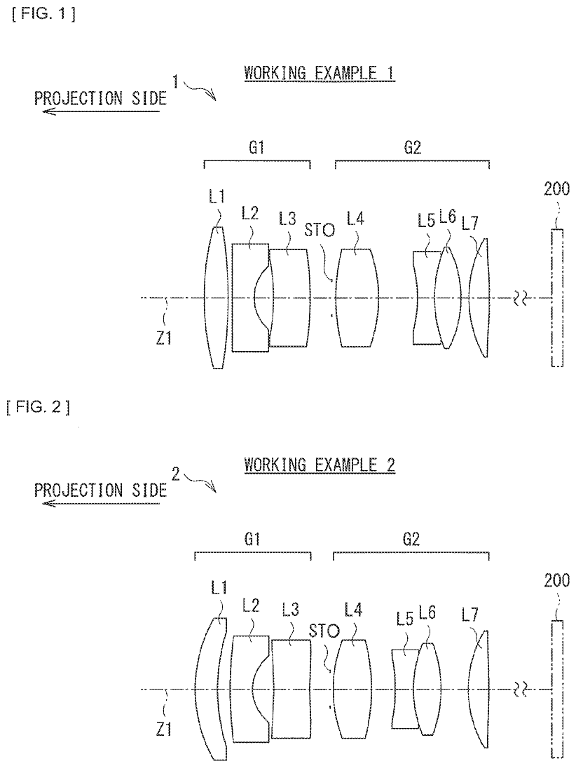

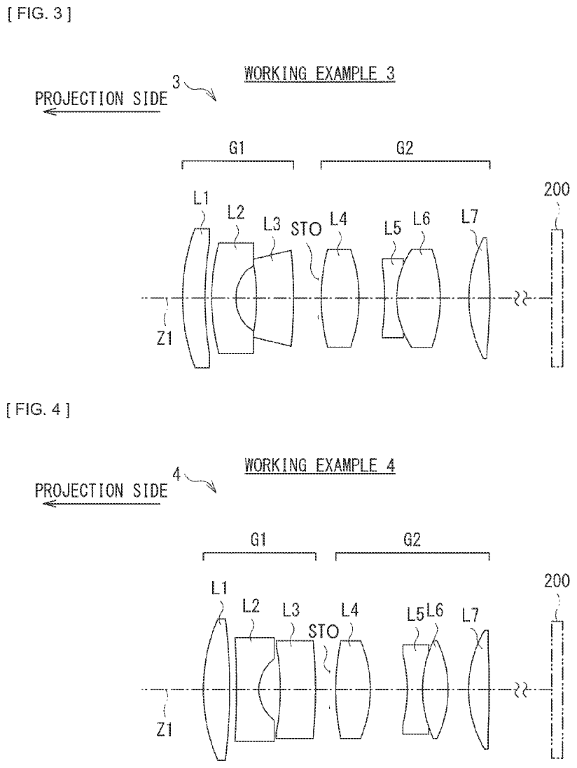

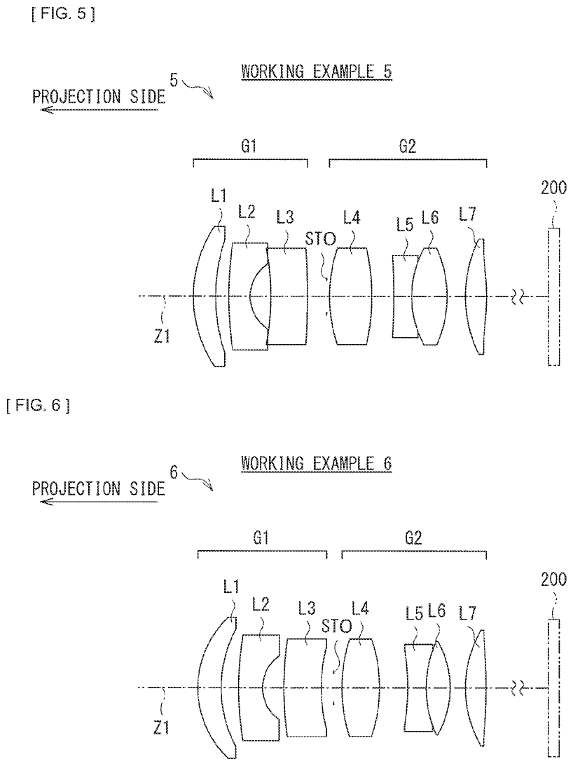

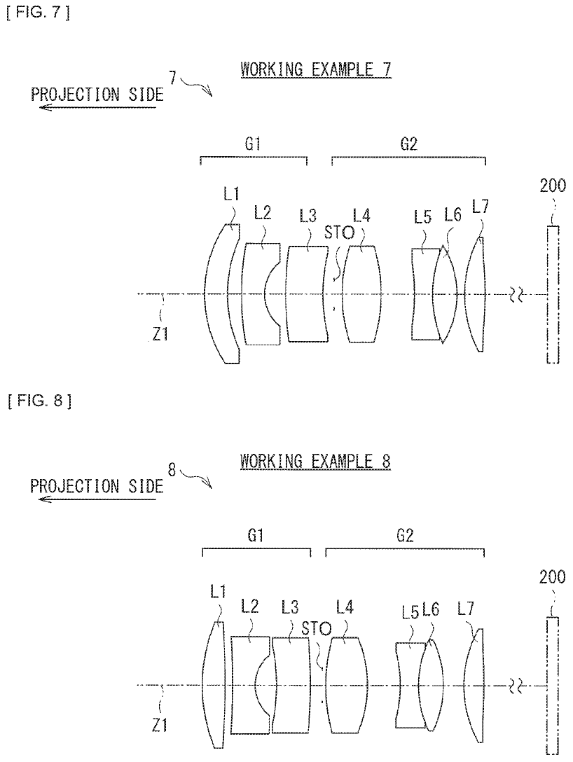

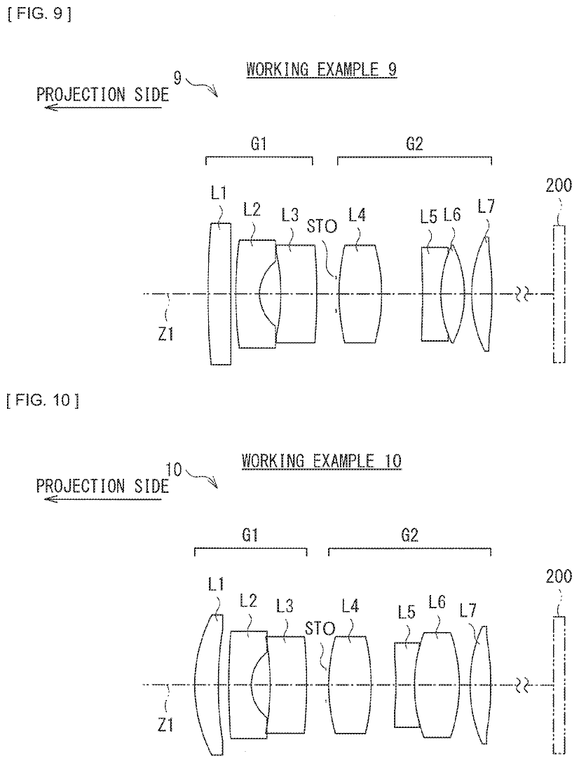

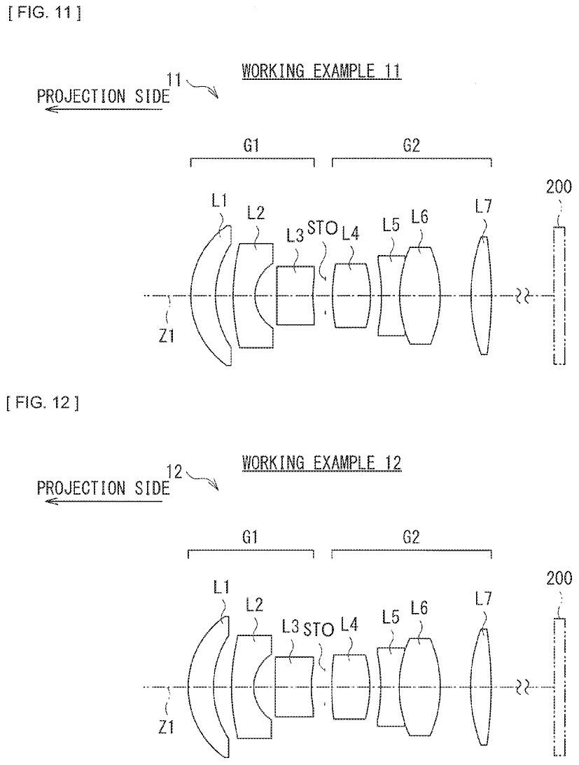

FIG. 1 illustrates a projection lens 1 of a first configuration example according to an embodiment of the present disclosure. FIGS. 2 to 12 illustrate projection lenses 2 to 12 of the second to twelfth configuration examples, respectively. Respective Numerical Working Examples in which specific numerical values are applied to these configuration examples are described later. In FIGS. 1 to 12, Z1 denotes an optical axis.

In the following, a configuration of the projection lens according to an embodiment of the present disclosure is described in association with projection lenses 1 to 12 of the respective configuration examples illustrated in FIG. 1, etc. where appropriate; however, the technology according to the present disclosure is not limited to illustrated configuration examples.

In FIGS. 1 to 12, the left side of the sheet is set as projection side, while the right side of the sheet is set as side of an image to be projected. The image to be projected is, for example, an image displayed on a display device 20. An optical device such as a polarization device may be disposed between the display device 20 and the projection lens.

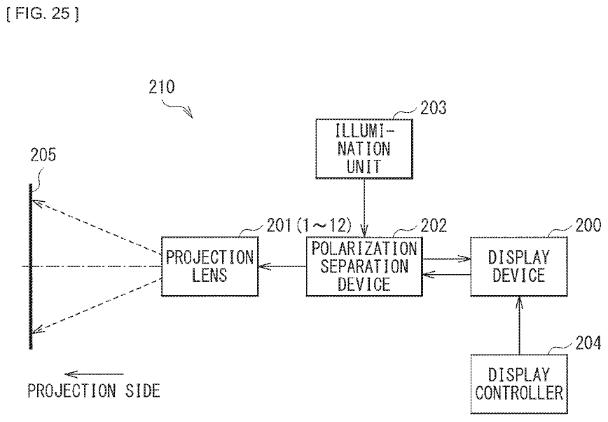

The projection lens according to the present embodiment is applied to, for example, a projection lens 201 in a projection apparatus 210 illustrated in FIG. 25. The projection apparatus 210 includes a display device 200, the projection lens 201, a polarization separation device 202, an illumination unit 203, and a display controller 204.

The illumination unit 203 includes, for example, a laser light source and an illumination optical system that uniformizes light from the laser light source. The illumination unit 203 emits illumination light for image projection. The display device 200 is illuminated by the illumination light emitted from the illumination unit 203 via the polarization separation device 202.

The display device 200 modulates the illumination light for image projection on the basis of picture data supplied from the display controller 204 to generate an image. The display device 200 is, for example, a reflective liquid crystal device such as a liquid crystal on silicon (LCOS). The image generated by the display device 200 is projected onto a screen 205 via the polarization separation device 202 and the projection lens 201.

It is to be noted that, although FIG. 25 illustrates a configuration example in a case where the display device 200 is employed as a reflective device, the projection lens according to the present embodiment is also applicable to a projection apparatus using a transmissive display device.

The projection lens according to the present embodiment substantially includes two lens groups in which a first lens group G1 having negative refractive power as a whole, an aperture stop STO, and a second lens group G2 having positive refractive power as a whole are disposed along the optical axis Z1 in order from the projection side toward the side of the image to be projected.

The first lens group G1 includes a predetermined negative lens including a material having a linear expansion coefficient equal to or more than 3*10⁻⁵/° C.

More specifically, the first lens group G1 desirably includes a first lens L1 having positive refractive power, a second lens L2 having negative refractive power, and a third lens L3 in order from the projection side toward the side of the image to be projected. The second lens L2 is desirably a predetermined negative lens including a material having a linear expansion coefficient equal to or more than 3*10⁻⁵/° C. The third lens L3 desirably has negative refractive power.

The second lens group G2 includes a predetermined positive lens including a material having a linear expansion coefficient equal to or more than 3*10⁻⁵/° C.

More specifically, the second lens group G2 desirably includes a fourth lens L4 having positive refractive power, a cemented lens including a fifth lens L5 and a sixth lens L6 and having negative refractive power as a whole, and a seventh lens L7 having positive refractive power, in order from the projection side toward the side of the image to be projected. The seventh lens L7 is desirably a predetermined positive lens including a material having a linear expansion coefficient equal to or more than 3*10⁻⁵/° C. Desirably, the fifth lens L5 has negative refractive power and the sixth lens L6 has positive refractive power.

Other than those described above, the projection lens according to the present embodiment desirably satisfies predetermined conditional expressions, etc. described later.

### 2. WORKINGS AND EFFECTS

Next, description is given of workings and effects of the projection lens according to the present embodiment. In addition, description is given of a desirable configuration of the projection lens according to the present embodiment.

It is to be noted that the effects described herein are merely illustrative and not limiting, and other effects may be provided.

According to the projection lens of the present embodiment, a two-group configuration as a whole is adopted with an aperture stop STO being interposed therebetween, thus intending to achieve optimization of configurations of respective lens groups. This makes it possible to achieve high optical performance as well as performance superior in mass productivity.

According to the projection lens of the present embodiment, using, for some of lenses, a material having a numerical value of a linear expansion coefficient equal to or more than 3*10⁻⁵/° C., which is superior in moldability and mass productivity, allows for suppression of manufacturing costs. In particular, using a material having a numerical value of a linear expansion coefficient equal to or more than 3*10⁻⁵/° C. for a predetermined negative lens in the first lens group G1 and a predetermined positive lens in the second lens group G2 allows for suppression of focus variation, thus achieving favorable focus characteristics. The focus variation becomes an issue due to influences such as a change in a linear expansion coefficient, a change in a temperature refractive index, and a change in a radius of curvature in a situation where a temperature in a use environment is changed, which tend to be issues in a material having a linear expansion coefficient.

It is to be noted that, in the first lens group G1, lenses other than the second lens L2 may include a material having a linear expansion coefficient equal to or more than 3*10⁻⁵/° C. Further, in the second lens group G2, lenses other than the seventh lens L7 may include a material having a linear expansion coefficient equal to or more than 3*10⁻⁵/° C. A combination other than the combination of the second lens L2 and the seventh lens L7 may be employed to suppress the variation in the focus characteristics when the temperature changes while suppressing the manufacturing cost.

The projection lens according to the present embodiment desirably satisfies the following conditional expression (1):

12.0<f/|fa/fb|<36.0 (1)

where

f denotes a focal distance of a total lens system in a d-line,

fa denotes a focal distance of a predetermined negative lens in the d-line, and

fb denotes a focal distance of a predetermined positive lens in the d-line.

The conditional expression (1) represents a relationship between the focal distance of the predetermined negative lens including a material having a linear expansion coefficient equal to or more than 3*10⁻⁵/° C. disposed in front of the aperture stop STO and the focal distance of the predetermined positive lens including a material having a linear expansion coefficient equal to or more than 3*10⁻⁵/° C. disposed behind the aperture stop STO, with respect to the focal distance of the total lens system. By determining the focal distance of the predetermined negative lens and the focal distance of the predetermined positive lens to fall within a range of the conditional expression (1), it is possible to achieve favorable focus characteristics and thus to achieve optical performance suitable for a high-definition display device even when the temperature in the use environment changes, while securing an appropriate projection angle of view and while favorably correcting various aberrations that occur. In addition, it becomes possible to suppress the manufacturing cost and thus to provide a lens having favorable resolution characteristics at a relatively low cost. In addition, it is possible to suppress occurrence of coma aberration and field curvature in the periphery. In consideration of the focus characteristic at this environmental temperature and aberration correction power, it is necessary for the conditional expression (1) to be within the above numerical range.

In the projection lens according to the present embodiment, it is desirable that at least one surface (one surface or both surfaces) of the predetermined negative lens and at least one surface (one surface or both surfaces) of the predetermined positive lens be each aspherical. The use of an aspherical surface for the predetermined negative lens and the predetermined positive lens makes it highly possible to correct off-axis aberration, in particular, field curvature and distortion aberration. Although the advantages of the manufacturing cost have been mentioned above, it is a great advantage that the manufacturing cost does not change much even when the aspherical surface is used in this manner.

It is to be noted that, in order to achieve the effect of the conditional expression (1) described above more favorably, it is more desirable to set the numerical range of the conditional expression (1) as in the following conditional expression (1)′:

15.0<f/|fa/fb|<29.0 (1)′.

The projection lens according to the present embodiment desirably satisfies the following conditional expression (2):

1.9<|(Nda/fa)/(Ndb/fb)|<3.0 (2)

where

fa denotes the focal distance of the predetermined negative lens in the d-line,

fb denotes the focal distance of the predetermined positive lens in the d-line,

Nda denotes a refractive index of the predetermined negative lens in the d-line, and

Ndb denotes a refractive index of the predetermined positive lens in the d-line.

The conditional expression (2) represents a relationship between a refractive index and refractive power of a material used in each of the predetermined negative lens and the predetermined positive lens. When the numerical value of the conditional expression (2) is too small, the ratio between the refractive index and the refractive power of the predetermined positive lens becomes too large with respect to the relationship between the refractive index and the refractive power of the predetermined negative lens. This results in, when the temperature in the use environment fluctuates, movement of the focus at the same time as well, thus making it less likely to achieve favorable resolution characteristics. Further, even when the numerical value of the conditional expression (2) becomes too large as well, the relationship between the refractive index and the refractive power of the predetermined positive lens becomes too small this time, thus making it less likely to achieve favorable resolution characteristics, as well. In consideration of this condition, it is necessary for the conditional expression (2) to be within the above numerical range.

It is to be noted that, in order to achieve the effect of the conditional expression (2) described above more favorably, it is more desirable to set the numerical range of the conditional expression (2) as in the following conditional expression (2)′:

2.1<|(Nda/fa)/(Ndb/fb)|<2.7 (2)′.

Further, the projection lens according to the present embodiment desirably satisfies the following conditional expressions (3) and (4):

5.0<|((Ra1+Ra2)/(Ra1−Ra2))*fa|<14.0 (3)

1.0<1((Rb1+Rb2)/(Rb1−Rb2))*fb|<16.0 (4)

where

fa denotes the focal distance of the predetermined negative lens in the d-line,

fb denotes the focal distance of the predetermined positive lens in the d-line,

Ra1 denotes a radius of curvature of a surface of the predetermined negative lens on the projection side,

Ra2 denotes a radius of curvature of a surface of the predetermined negative lens on the side of the image to be projected,

Rb1 denotes a radius of curvature of a surface of the predetermined positive lens on the projection side, and

Rb2 denotes a radius of curvature of a surface of the predetermined positive lens on the side of the image to be projected.

The conditional expression (3) represents a relationship among the focal distance, the radius of curvature of the surface on the projection side, and the radius of curvature of the surface on the side of the image to be projected, in the predetermined negative lens. The conditional expression (4) represents a relationship among the focal distance, the radius of curvature of the surface on the projection side, and the radius of curvature of the surface on the side of the image to be projected, in the predetermined positive lens. When the conditional expression (3) and the conditional expression (4) do not fall within the above numerical range, it becomes difficult to maintain favorable aberration correction power while maintaining focal resistance to fluctuation in the environmental temperature. In consideration of this condition, it is necessary for the conditional expression (3) and the conditional expression (4) to be within the above numerical range.

It is to be noted that, in order to achieve the effects of the conditional expressions (3) and (4) more favorably, it is more desirable to set the numerical ranges of the conditional expressions (3) and (4) as in the following conditional expressions (3)′ and (4)′:

6.0<|((Ra1+Ra2)/(Ra1−Ra2))*fa|<13.0 (3)′

1.5<|((Rb1+Rb2)/(Rb1−Rb2))*fb|<14.0 (4)′.

The projection lens according to the present embodiment desirably satisfies the following conditional expressions (5) and (6):

0.35<|(fa/(Ca1+Ca2)|<0.65 (5)

0.65<|(fb/(Cb1+Cb2)|<0.95 (6)
where
fa denotes the focal distance of the predetermined negative lens in the d-line,
fb denotes the focal distance of the predetermined positive lens in the d-line,
Ca1 denotes an effective diameter of a surface of the predetermined negative lens on the projection side in the d-line,

Ca2 denotes an effective diameter of a surface of the predetermined negative lens on the side of the image to be projected in the d-line,

Cb1 denotes an effective diameter of a surface of the predetermined positive lens on the projection side in the d-line, and

Cb2 denotes an effective diameter of a surface of the predetermined positive lens on the side of the image to be projected in the d-line.

The conditional expression (5) represents a relationship among the focal distance, the effective diameter of the surface on the projection side, and the effective diameter of the surface on the side of the image to be projected, in the predetermined negative lens. The conditional expression (6) represents a relationship among the focal distance, the effective diameter of the surface on the projection side, and the effective diameter of the surface on the side of the image to be projected, in the predetermined positive lens. When the conditional expression (5) and the conditional expression (6) do not fall within the above numerical range, it becomes difficult to maintain favorable aberration correction power while maintaining focal resistance to fluctuation in the environmental temperature. In consideration of this condition, it is necessary for the conditional expression (5) and the conditional expression (6) to be within the above numerical range.

It is to be noted that, in order to achieve the effects of the conditional expressions (5) and (6) more favorably, it is more desirable to set the numerical ranges of the conditional expressions (5) and (6) as in the following conditional expressions (5)′ and (6)′:

0.40<|(fa/(Ca1+Ca2)|<0.60 (5)′

0.70<|(fb/(Cb1+Cb2)|<0.90 (6)′.

Further, the projection lens according to the present embodiment desirably satisfies the following conditional expressions (7) and (8):

0.7<TR<1.7 (7)

3.5<TL/f<8.0 (8)
where
TR denotes a projection ratio,
TL denotes a total lens length (air equivalent), and
f denotes the focal distance of the total lens system in the d-line.

The conditional expression (7) defines a projection ratio TR in the projection lens according to the present embodiment. The projection ratio TR is a value of a projection distance divided by horizontal dimension of an image on a projection surface (screen). When the projection ratio TR is too small, a horizontal angle of view becomes too wide as compared with an appropriate range in the projection lens, causing the correction power of aberration typified by distortion aberration and chromatic aberration to be insufficient, thus making it difficult to secure favorable image quality. When the projection ratio TR is too large, the angle of view becomes narrower than an appropriate range of horizontal angle of view of the projection lens, causing excessive correction although the aberration correction is favorable, thus leading to a necessity of considering replacement with an optical system that is able to further reduce the cost. In consideration of this condition, the conditional expression (7) within the above numerical range allows for achievement of preferable performance.

The conditional expression (8) represents a relationship of the total lens system (air equivalent) to the focal distance of the total lens system. When the numerical value of the TL/f is too small, the focal distance of the total lens system becomes too short with respect to the total lens system, thus causing the aberration correction to be insufficient as well as making it difficult to secure necessary flange back. Further, when the TL/f is too large, the focal distance is long with respect to the total optical length, thus making it difficult to correct the aberration appropriately and making it necessary to consider a change in the lens configuration.

It is to be noted that, in order to achieve the effects of the conditional expressions (7) and (8) more favorably, it is more desirable to set the numerical ranges of the conditional expressions (7) and (8) as in the following conditional expressions (7)′ and (8)′:

0.8<TR<1.5 (7)′

4.0<TL/f<7.2 (8)′.

Further, the projection lens according to the present embodiment desirably satisfies the following conditional expression (9):

2.0<f/|fg1/fg2|<7.0 (9)

where

f denotes the focal distance of the total lens system in the d-line,

fg1 denotes a focal distance of the first lens group G1 in the d-line, and

fg2 denotes a focal distance of the second lens group G2 in the d-line.

The conditional expression (9) is a conditional expression for defining a focal distance between the first lens group G1 and the second lens group G2 with respect to the focal distance of the total lens system. By determining the focal distance of the total lens system, the focal distance of the first lens group G1, and the focal distance of the second lens group G2 to fall within the range of the conditional expression (9), it is possible to favorably correct various aberrations that occur while securing an appropriate projection angle of view and thus to achieve optical performance suitable for a high-definition display device. In addition, it is possible to suppress the occurrence of coma aberration and field curvature in the periphery. In consideration of this aberration correction, it is necessary for the conditional expression (9) to be within the above numerical range.

It is to be noted that, in order to achieve the effect of the conditional expression (9) described above more favorably, it is more desirable to set the numerical range of the conditional expression (9) as in the following conditional expression (9)′:

2.8<f/|fg1/fg2|<6.4 (9)′.

Further, in the projection lens according to the present embodiment, the first lens L1, the second lens L2, and the third lens L3 of the first lens group G1 are configured to be positive, negative, and negative, respectively, to thereby enable chromatic aberration to be appropriately corrected and aberration due to off-axis rays to be appropriately corrected as well.

Further, in the projection lens according to the present embodiment, the fourth lens L4 of the second lens group G2 enables field curvature that occurs off-axis to be appropriately corrected.

Further, in the projection lens according to the present embodiment, designing the fifth lens L5 and the sixth lens L6 as a cemented lens and appropriately designing a radius of curvature, a refractive index, and Abbe number of the cemented lens make it possible to suppress chromatic aberration. The fifth lens L5 and the sixth lens L6 have negative refractive power in combination, and the fifth lens L5 has negative refractive power, thus making it advantageous for correction of aberration, in particular, correction of field curvature and distortion aberration.

In the projection lens according to the present embodiment, designing the seventh lens L7 to have positive refractive power allows rays incident on a lens periphery to be changed in accordance with positive refractive power as traveling from a paraxial axis to the lens periphery, which is effective in correcting the field curvature.

The projection lens according to the present embodiment desirably satisfies the following conditional expression (10):

νd6−νd5>20.0 (10)

where

νd5 denotes Abbe number of the fifth lens L5 in the d-line, and

νd6 denotes Abbe number of the sixth lens L6 in the d-line.

The conditional expression (10) defines a relationship between the Abbe numbers of the fifth lens L5 and the sixth lens L6. Using a glass material within the range of the conditional expression (10) for the fifth lens L5 and the sixth lens L6 makes it possible to correct chromatic aberration favorably. In addition, it is possible to suppress the occurrence of coma aberration and field curvature in the periphery. In consideration of this aberration correction, the conditional expression (10) is desirably within the above numerical range.

It is to be noted that, in order to achieve the effect of the conditional expression (10) described above more favorably, it is more desirable to set the numerical range of the conditional expression (10) as in the following conditional expression (10)′:

νd6−νd5>30.0 (10)′.

Further, the projection lens according to the present embodiment desirably satisfies the following conditional expression (11):

3.0<|f1/f2|<18.0 (11)

where

f1 denotes a focal distance of the first lens L1 in the d-line, and

f2 denotes a focal distance of the second lens L2 in the d-line.

The conditional expression (11) is a conditional expression related to appropriate power distribution between the first lens L1 and the second lens L2 under such a configuration. One reason for using the absolute value for the focal distance of the second lens L2 is that the second lens L2 has negative power. Arranging the power of the first lens L1 and the second lens L2 as in the conditional expression (11) allows for achievement of a favorable aberration correction effect. When |f1/f2| exceeds the upper limit of the conditional expression (11), the power of the second lens L2 becomes excessively large, making it difficult to correct the off-axis aberration, in particular, correction of astigmatism and field curvature, resulting in impairment in assembly when manufacturing. In addition, it is also disadvantageous to enlarging the horizontal angle of view. On the contrary, when |f1/f2| exceeds the lower limit of the conditional expression (11), the power of the second lens L2 is weak, which is a disadvantageous condition for achromatization. In consideration of this balance, it is preferable for the conditional expression (11) to be within the above numerical range.

It is to be noted that, in order to achieve the effect of the conditional expression (11) described above more favorably, it is more desirable to set the numerical range of the conditional expression (11) as in the following conditional expression (11)′:

3.5<|f1/f2|<16.5 (11)′.

The projection lens according to the present embodiment desirably satisfies the following conditional expression (12):

0.4<|f5/f6|<1.2 (12)

where

f5 denotes a focal distance of the fifth lens L5 in the d-line, and

f6 denotes a focal distance of the sixth lens L6 in the d-line.

The conditional expression (12) is a conditional expression related to appropriate power distribution between the fifth lens L5 and the sixth lens L6 in the projection lens. When |f5/f6| exceeds the upper limit of the conditional expression (12), the power of the fifth lens L5 becomes excessively large, thus making it difficult to correct the off-axis aberration, in particular, the correction of astigmatism and field curvature. Further, when |f5/f6| exceeds the lower limit of the conditional expression (12), the power of the sixth lens L6 becomes excessively large, thus making it difficult to correct the off-axis aberration, in particular, the correction of astigmatism and field curvature. In consideration of the correction of the off-axis aberration, the conditional expression (12) is desirably within the above numerical range.

It is to be noted that, in order to achieve the effect of the conditional expression (12) described above more favorably, it is more desirable to set the numerical range of the conditional expression (12) as in the following conditional expression (12)′:

0.5<|f5/f6|<1.05 (12)′.

The projection lens according to the present embodiment desirably satisfies the following conditional expression (13):

0.3<|f/f7|<0.8 (13)

where

f denotes the focal distance of the total lens system in the d-line, and

f7 denotes a focal distance of the seventh lens L7 in the d-line.

The conditional expression (13) is a conditional expression related to appropriate power distribution between the total lens system and the seventh lens L7. When |f/f7| exceeds the upper limit of the conditional expression (13), the power of the seventh lens L7 becomes excessively large, making it difficult to correct off-axis aberrations, in particular, correction of distortion aberration, thus resulting in impairment in assembly when manufacturing. On the contrary, when |f/f7| exceeds the lower limit of the conditional expression (13), the power of the seventh lenses L7 becomes too weak, thus making it difficult to secure telecentricity for the display device.

It is to be noted that, in order to achieve the effect of the conditional expression (13) described above more favorably, it is more desirable to set the numerical range of the conditional expression (13) as in the following conditional expression (13)′:

0.35<|f/f7|<0.65 (13)′.

### Working Examples

### 3. NUMERICAL WORKING EXAMPLES OF LENSES

Description is given next of specific numerical working examples of the projection lenses 1 to 12 according to the present embodiment. Description is given here of numerical working examples in which specific numerical values are applied to the projection lenses 1 to 12 of respective configuration examples illustrated in FIGS. 1 to 12.

It is to be noted that meanings, etc. of respective symbols indicated in the following tables and descriptions are as follows. “Si” denotes number of i-th surface counting from the projection side to the side of the image to be projected. “Ri” denotes a value (mm) of a paraxial radius of curvature of the i-th surface. “Di” denotes a value (mm) of an on-axis surface interval (a thickness of lens center or an air space) between the i-th surface and (i+1)-th surface. “Ndi” denotes a value of a refractive index in a d-line (wavelength of 587.6 nm) of a lens, etc. that starts from the i-th surface. “νdi” denotes a value of Abbe number in the d-line of the lens, etc. that starts from the i-th surface. A surface denoted as “STO” is the aperture stop STO.

Each of the numerical working examples includes a lens surface formed into an aspherical surface. A shape of the aspherical surface is defined by the following aspherical surface expression. In the following aspherical surface expression, a depth of the aspherical surface is defined as Z, and a height from the optical axis Z1 is defined as Y. R denotes a paraxial radius of curvature, K denotes a conic constant, and Ai denotes an i-th order (i denotes an integer of 3 or more) aspherical coefficient. Incidentally, in each of Tables that indicate the following aspherical coefficients, “E-n” denotes an exponential expression using 10 as a base, i.e., “minus n-th power of 10”. For example, “0.12345E-05” denotes “0.12345×(minus fifth power of 10)”.

(Aspherical Surface Expression)

$$Z = \frac{{Y}^{2} \text{/} R}{1 + \sqrt{1 - ( 1 + K ) {( Y \text{/} R )}^{2}}} + \sum A i \cdot {Y}^{i}$$

### [Configuration Common to Each Numerical Working Example]

The projection lenses 1 to 12 to which the following respective Numerical Working Examples 1 to 12 are applied each have a configuration that satisfies the above-described <1. Basic Configuration of Lenses>. That is, the projection lenses 1 to 12 each have the configuration in which the first lens group G1 having the negative refractive power as a whole, the aperture stop STO, and the second lens group G2 having the positive refractive power as a whole are disposed in order from the projection side toward the side of the image to be projected.

In each of the projection lenses 1 to 12, the first lens group G1 includes the first lens L1 having the positive refractive power, the second lens L2 having the negative refractive power, and the third lens L3 having the negative refractive power, in order from the projection side toward the side of the image to be projected. The second lens L2 is the predetermined negative lens including the material having a linear expansion coefficient equal to or more than 3*10⁻⁵/° C.

In each of the projection lenses 1 to 12, the second lens group G2 includes the fourth lens L4 having the positive refractive power, the cemented lens including the fifth lens L5 and the sixth lens L6 and having the negative refractive power as a whole, and the seventh lens L7 having the positive refractive power, in order from the projection side toward the side of the image to be projected. The seventh lens L7 is the predetermined positive lens including the material having a linear expansion coefficient equal to or more than 3*10⁻⁵/° C.

Further, in each of the projection lenses 1 to 12, both surfaces (the third surface and the fourth surface) of the second lens L2, which is the predetermined negative lens, and both surfaces (the twelfth surface and the thirteenth surface) of the seventh lens L7, which is the predetermined positive lens, are aspherical.

### Numerical Working Example 1

[Table 1] lists basic lens data of Numerical Working Example 1 in which specific numerical values are applied to the projection lens 1. Further, aspherical data are listed in [Table 2].

TABLE 1
Working Example 1 Lens Data

| | Ri | | | |
|---|---|---|---|---|
| Si | Radius of | Di | Ndi | νdi |
| Surface No. | Curvature | Interval | Refractive Index | Abbe Number |
| 1 | 21.040 | 3.000 | 1.497 | 81.6 |
| 2 | 41.521 | 0.892 | — | — |
| 3 | 48.138 | 3.100 | 1.540 | 54.0 |
| 4 | 4.412 | 2.747 | — | — |
| 5 | −22.630 | 4.800 | 1.744 | 44.7 |
| 6 | −54.609 | 3.243 | — | — |
| STO | — | 0.400 | — | — |
| 7 | 21.105 | 5.056 | 1.755 | 27.5 |
| 8 | −14.868 | 3.288 | — | — |
| 9 | −36.243 | 1.668 | 1.847 | 23.8 |
| 10 | 9.655 | 5.666 | 1.594 | 67.0 |
| 11 | −15.508 | 3.750 | — | — |
| 12 | 14.416 | 2.727 | 1.540 | 54.0 |
| 13 | −51.816 | 13.517 | — | — |

TABLE 2
Working Example 1 Aspherical Data

| Si | K | | | |
|---|---|---|---|---|
| Surface | Conic | | | |
| No. | Coefficient | Fourth | Sixth | Eighth |
| 3 | 0.0000E+00 | 4.1413E−04 | −6.0034E−06 | 4.1157E−08 |
| 4 | 0.0000E+00 | 5.5780E−04 | 2.4273E−05 | −1.0266E−06 |
| 12 | 0.0000E+00 | −9.3902E−05 | 9.4060E−07 | 2.6844E−08 |
| 13 | 0.0000E+00 | −4.7967E−05 | 1.0739E−06 | 3.1065E−08 |

| Si | | | |
|---|---|---|---|
| Surface No. | Tenth | Twelfth | Fourteenth |
| 3 | — | — | — |
| 4 | — | — | — |
| 12 | −5.6814E−11 | — | — |
| 13 | −8.9491E−11 | — | — |

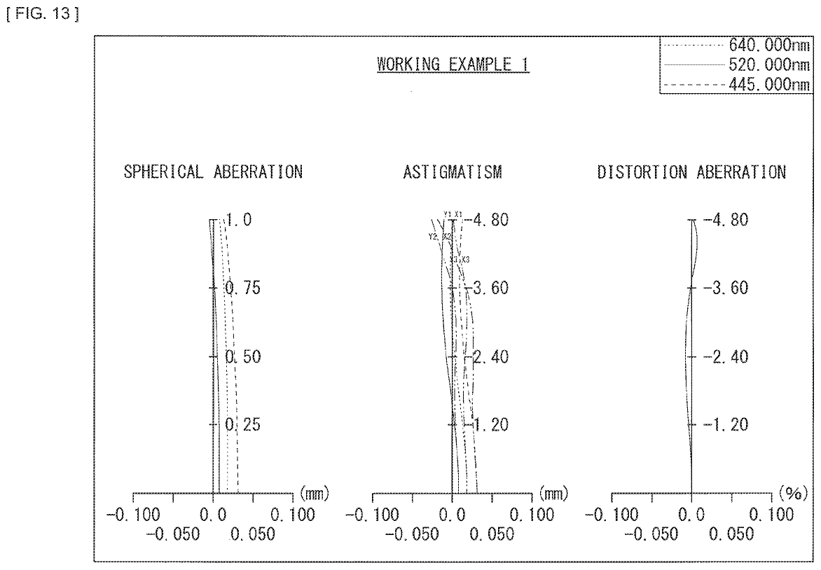

FIG. 13 illustrates various aberrations of the projection lens 1 according to Numerical Working Example 1. FIG. 13 illustrates, as various aberrations, spherical aberration, astigmatism (field curvature), and distortion aberration. In the astigmatism diagram, S or X indicates a value in a sagittal image plane, and T or Y indicates a value in a meridional image plane. Each of the aberration diagrams indicates values with a wavelength of 520.000 nm as a reference wavelength. The spherical aberration diagram and the astigmatism diagram also indicate values of a wavelength of 640.000 nm and a wavelength of 445.000 nm. The same applies also to the aberration diagrams in subsequent other Numerical Working Examples.

As can be appreciated from each of the aberration diagrams, it is obvious, in Numerical Working Example 1, that the projection lens 1 has favorable optical performance corresponding to a high-pixel display device.

### Numerical Working Example 2

[Table 3] lists basic lens data of Numerical Working Example 2 in which specific numerical values are applied to the projection lens 2. Further, aspherical data are listed in [Table 4].

TABLE 3
Working Example 2 Lens Data

| | Ri | | | |
|---|---|---|---|---|
| Si | Radius of | Di | Ndi | νdi |
| Surface No. | Curvature | Interval | Refractive Index | Abbe Number |
| 1 | 15.095 | 3.000 | 1.806 | 40.9 |
| 2 | 23.368 | 1.583 | — | — |
| 3 | 950.000 | 2.900 | 1.540 | 54.0 |
| 4 | 4.554 | 2.800 | — | — |
| 5 | −51.514 | 4.800 | 1.744 | 44.7 |
| 6 | 216.690 | 2.612 | — | — |
| STO | — | 0.400 | — | — |
| 7 | 14.870 | 5.000 | 1.755 | 27.5 |
| 8 | −21.881 | 3.051 | — | — |
| 9 | −21.414 | 2.400 | 1.847 | 23.8 |
| 10 | 12.447 | 3.656 | 1.594 | 67.0 |
| 11 | −13.345 | 3.572 | — | — |
| 12 | 12.652 | 2.740 | 1.540 | 54.0 |
| 13 | −44.929 | 13.218 | — | — |

TABLE 4
Working Example 2 Aspherical Data

| Si | K | | | |
|---|---|---|---|---|
| Surface | Conic | | | |
| No. | Coefficient | Fourth | Sixth | Eighth |
| 3 | 0.0000E+00 | 4.9521E−04 | −8.6255E−06 | 6.9821E−08 |
| 4 | 0.0000E+00 | 3.0040E−04 | 2.4911E−05 | −2.5890E−06 |
| 12 | 0.0000E+00 | −5.1765E−05 | 1.7640E−06 | 2.1863E−08 |
| 13 | 0.0000E+00 | 8.7069E−05 | 2.2661E−06 | 2.5496E−08 |

| Si | | | |
|---|---|---|---|
| Surface No. | Tenth | Twelfth | Fourteenth |
| 3 | — | — | — |
| 4 | — | — | — |
| 12 | −3.8300E−10 | — | — |
| 13 | −5.3804E−10 | — | — |

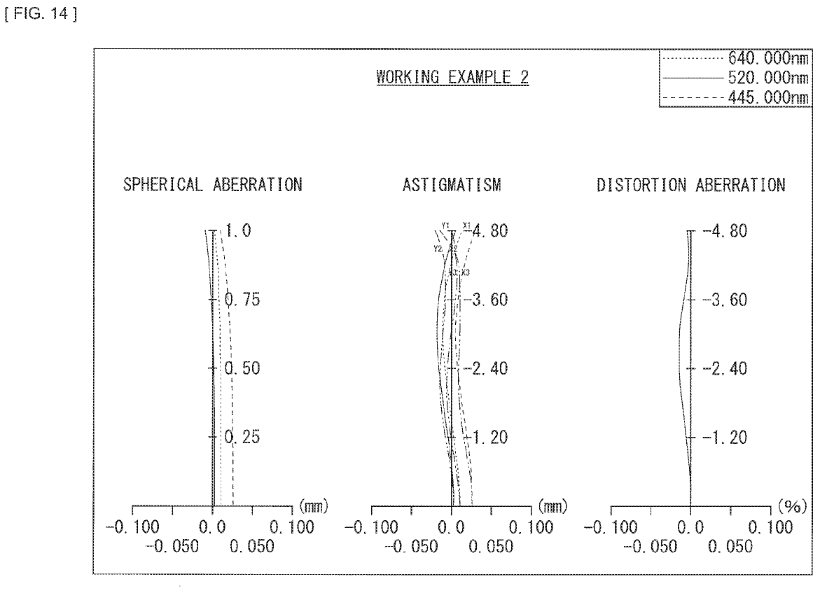

FIG. 14 illustrates various aberrations of the projection lens 2 according to Numerical Working Example 2.

As can be appreciated from each of the aberration diagrams, it is obvious, in Numerical Working Example 2, that the projection lens 2 has favorable optical performance corresponding to a high-pixel display device.

### Numerical Working Example 3

[Table 5] lists basic lens data of Numerical Working Example 3 in which specific numerical values are applied to the projection lens 3. Further, aspherical data are listed in [Table 6].

TABLE 5
Working Example 3 Lens Data

| | Ri | | | |
|---|---|---|---|---|
| Si | Radius of | Di | Ndi | νdi |
| Surface No. | Curvature | Interval | Refractive Index | Abbe Number |
| 1 | 21.040 | 3.000 | 1.806 | 40.9 |
| 2 | 41.521 | 0.892 | — | — |
| 3 | 48.138 | 3.100 | 1.540 | 54.0 |
| 4 | 4.412 | 2.747 | — | — |
| 5 | −22.630 | 4.800 | 1.744 | 44.7 |
| 6 | −54.609 | 3.243 | — | — |
| STO | — | 0.400 | — | — |
| 7 | 21.105 | 5.056 | 1.755 | 27.5 |
| 8 | −14.868 | 3.288 | — | — |
| 9 | −36.243 | 1.668 | 1.921 | 24.0 |
| 10 | 9.655 | 5.666 | 1.594 | 67.0 |
| 11 | −15.508 | 3.750 | — | — |
| 12 | 14.416 | 2.727 | 1.540 | 54.0 |
| 13 | −51.816 | 13.580 | — | — |

TABLE 6
Working Example 3 Aspherical Data

| Si | K | | | |
|---|---|---|---|---|
| Surface | Conic | | | |
| No. | Coefficient | Fourth | Sixth | Eighth |
| 3 | 0.0000E+00 | 4.1413E−04 | −6.0034E−06 | 4.1157E−08 |
| 4 | 0.0000E+00 | 5.5780E−04 | 2.4273E−05 | −1.0266E−06 |
| 12 | 0.0000E+00 | −9.3902E−05 | 9.4060E−07 | 2.6844E−08 |
| 13 | 0.0000E+00 | −4.7967E−05 | 1.0739E−06 | 3.1065E−08 |

| Si | | | |
|---|---|---|---|
| Surface No. | Tenth | Twelfth | Fourteenth |
| 3 | — | — | — |
| 4 | — | — | — |
| 12 | −5.6814E−11 | — | — |
| 13 | −8.9491E−11 | — | — |

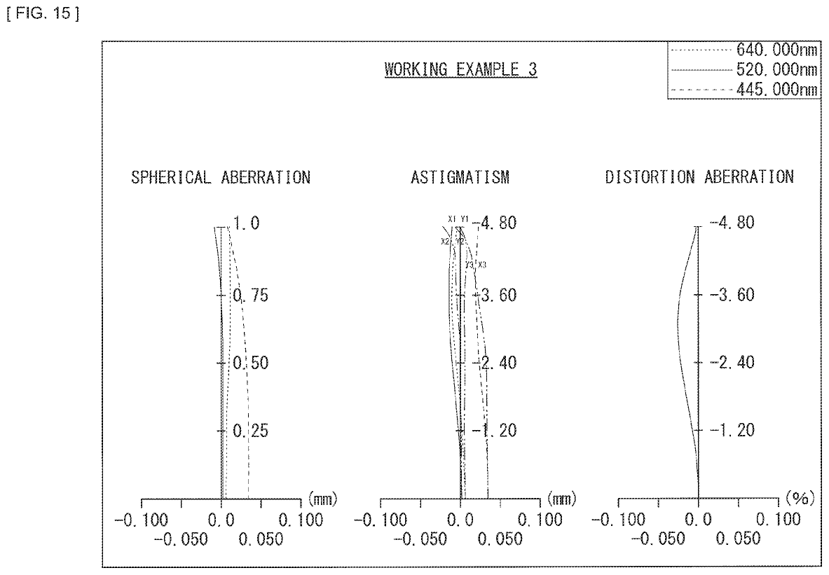

FIG. 15 illustrates various aberrations of the projection lens 3 according to Numerical Working Example 3.

As can be appreciated from each of the aberration diagrams, it is obvious, in Numerical Working Example 3, that the projection lens 3 has favorable optical performance corresponding to a high-pixel display device.

### Numerical Working Example 4

[Table 7] lists basic lens data of Numerical Working Example 4 in which specific numerical values are applied to the projection lens 4. Further, aspherical data are listed in [Table 8].

TABLE 7
Working Example 4 Lens Data

| | Ri | | | |
|---|---|---|---|---|
| Si | Radius of | Di | Ndi | νdi |
| Surface No. | Curvature | Interval | Refractive Index | Abbe Number |
| 1 | 18.681 | 3.439 | 1.497 | 81.6 |
| 2 | −68.210 | 0.940 | — | — |
| 3 | −83.083 | 3.000 | 1.540 | 54.0 |
| 4 | 4.341 | 2.796 | — | — |
| 5 | −24.050 | 4.500 | 1.744 | 44.7 |
| 6 | −65.646 | 1.955 | — | — |
| STO | — | 0.800 | — | — |
| 7 | 26.146 | 4.600 | 1.755 | 27.5 |
| 8 | −12.952 | 4.813 | — | — |
| 9 | −16.860 | 2.000 | 1.847 | 23.8 |
| 10 | 12.548 | 3.400 | 1.594 | 67.0 |
| 11 | −11.601 | 2.627 | — | — |
| 12 | 13.134 | 2.710 | 1.540 | 54.0 |
| 13 | −61.294 | 13.134 | — | — |

TABLE 8
Working Example 4 Aspherical Data

| Si | K | | | |
|---|---|---|---|---|
| Surface | Conic | | | |
| No. | Coefficient | Fourth | Sixth | Eighth |
| 3 | 0.0000E+00 | 3.8269E−04 | −1.1638E−05 | 1.0704E−07 |
| 4 | 0.0000E+00 | 4.4436E−04 | 3.9292E−05 | −6.0857E−06 |
| 12 | 0.0000E+00 | −1.0943E−05 | 1.8004E−06 | 1.3177E−08 |
| 13 | 0.0000E+00 | 8.1245E−05 | 2.2248E−06 | 5.9186E−09 |

| Si | | | |
|---|---|---|---|
| Surface No. | Tenth | Twelfth | Fourteenth |
| 3 | — | — | — |
| 4 | — | — | — |
| 12 | −5.2453E−10 | — | — |
| 13 | −6.0405E−10 | — | — |

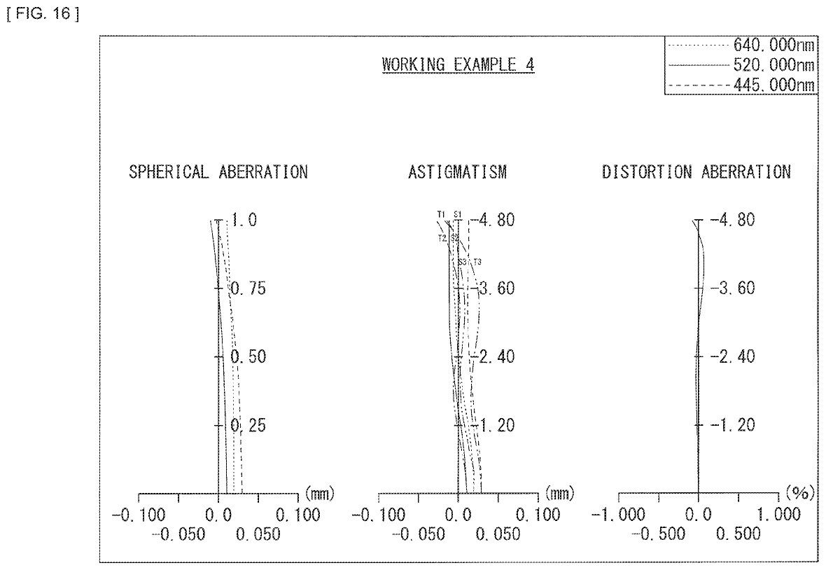

FIG. 16 illustrates various aberrations of the projection lens 4 according to Numerical Working Example 4.

As can be appreciated from each of the aberration diagrams, it is obvious, in Numerical Working Example 4, that the projection lens 4 has favorable optical performance corresponding to a high-pixel display device.

### Numerical Working Example 5

[Table 9] lists basic lens data of Numerical Working Example 5 in which specific numerical values are applied to the projection lens 5. Further, aspherical data are listed in [Table 10].

TABLE 9
Working Example 5 Lens Data

| | Ri | | | |
|---|---|---|---|---|
| Si | Radius of | Di | Ndi | νdi |
| Surface No. | Curvature | Interval | Refractive Index | Abbe Number |
| 1 | 13.328 | 3.000 | 1.806 | 40.9 |
| 2 | 19.316 | 1.717 | — | — |
| 3 | 255.966 | 2.900 | 1.540 | 54.0 |
| 4 | 4.406 | 2.579 | — | — |
| 5 | −28.769 | 4.800 | 1.744 | 44.7 |
| 6 | −101.588 | 2.486 | — | — |
| STO | — | 0.400 | — | — |
| 7 | 16.034 | 5.500 | 1.755 | 27.5 |
| 8 | −26.016 | 2.937 | — | — |
| 9 | −91.452 | 2.400 | 1.847 | 23.8 |
| 10 | 10.772 | 4.627 | 1.497 | 81.6 |
| 11 | −13.023 | 2.423 | — | — |
| 12 | 14.859 | 2.740 | 1.540 | 54.0 |
| 13 | −31.534 | 13.229 | — | — |

TABLE 10
Working Example 5 Aspherical Data

| Si | K | | | |
|---|---|---|---|---|
| Surface | Conic | | | |
| No. | Coefficient | Fourth | Sixth | Eighth |
| 3 | 0.0000E+00 | 5.2011E−04 | −8.9956E−06 | 7.3464E−08 |
| 4 | 0.0000E+00 | 3.0238E−04 | 3.1255E−05 | −3.1125E−06 |
| 12 | 0.0000E+00 | −5.9472E−05 | 2.0273E−06 | 2.3014E−08 |
| 13 | 0.0000E+00 | 3.4611E−05 | 1.7926E−06 | 4.1465E−08 |

| Si | | | |
|---|---|---|---|
| Surface No. | Tenth | Twelfth | Fourteenth |
| 3 | — | — | — |
| 4 | — | — | — |
| 12 | −2.0657E−10 | — | — |
| 13 | −4.3141E−10 | — | — |

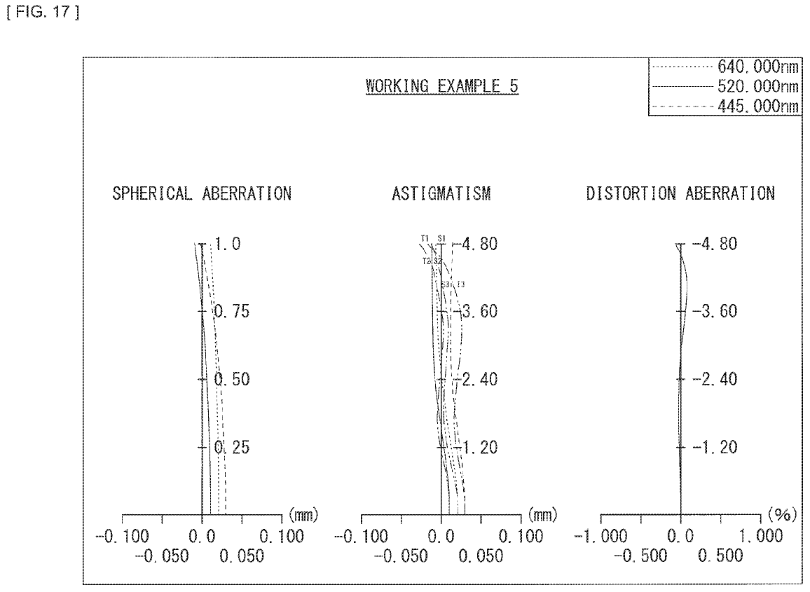

FIG. 17 illustrates various aberrations of the projection lens 5 according to Numerical Working Example 5.

As can be appreciated from each of the aberration diagrams, it is obvious, in Numerical Working Example 5, that the projection lens 5 has favorable optical performance corresponding to a high-pixel display device.

### Numerical Working Example 6

[Table 11] lists basic lens data of Numerical Working Example 6 in which specific numerical values are applied to the projection lens 6. Further, aspherical data are listed in [Table 12].

TABLE 11
Working Example 6 Lens Data

| | Ri | | | |
|---|---|---|---|---|
| Si | Radius of | Di | Ndi | νdi |
| Surface No. | Curvature | Interval | Refractive Index | Abbe Number |
| 1 | 10.453 | 3.048 | 1.583 | 59.5 |
| 2 | 13.407 | 2.397 | — | — |
| 3 | 2247.331 | 3.100 | 1.540 | 54.0 |
| 4 | 4.454 | 2.800 | — | — |
| 5 | 37.054 | 4.800 | 1.744 | 44.7 |
| 6 | 18.447 | 1.705 | — | — |
| STO | — | 1.006 | — | — |
| 7 | 15.858 | 5.000 | 1.755 | 27.5 |
| 8 | −16.624 | 3.779 | — | — |
| 9 | −28.023 | 2.400 | 1.847 | 23.8 |
| 10 | 11.846 | 3.084 | 1.497 | 81.6 |
| 11 | −10.336 | 2.065 | — | — |
| 12 | 13.365 | 2.740 | 1.540 | 54.0 |
| 13 | −37.636 | 13.228 | — | — |

TABLE 12
Working Example 6 Aspherical Data

| Si | K | | | |
|---|---|---|---|---|
| Surface | Conic | | | |
| No. | Coefficient | Fourth | Sixth | Eighth |
| 3 | 0.0000E+00 | 5.6801E−04 | −9.7920E−06 | 7.8067E−08 |
| 4 | 0.0000E+00 | 3.7506E−04 | 3.4520E−05 | −3.2985E−06 |
| 12 | 0.0000E+00 | −3.4136E−05 | 1.4920E−06 | 3.0474E−08 |
| 13 | 0.0000E+00 | 6.9271E−05 | 1.4494E−06 | 4.7105E−08 |

| Si | | | |
|---|---|---|---|
| Surface | | | |
| No. | Tenth | Twelfth | Fourteenth |
| 3 | — | — | — |
| 4 | — | — | — |
| 12 | −1.2746E−10 | 1.4141E−12 | −2.3824E−14 |
| 13 | −2.7405E−10 | 2.7618E−13 | −1.6472E−14 |

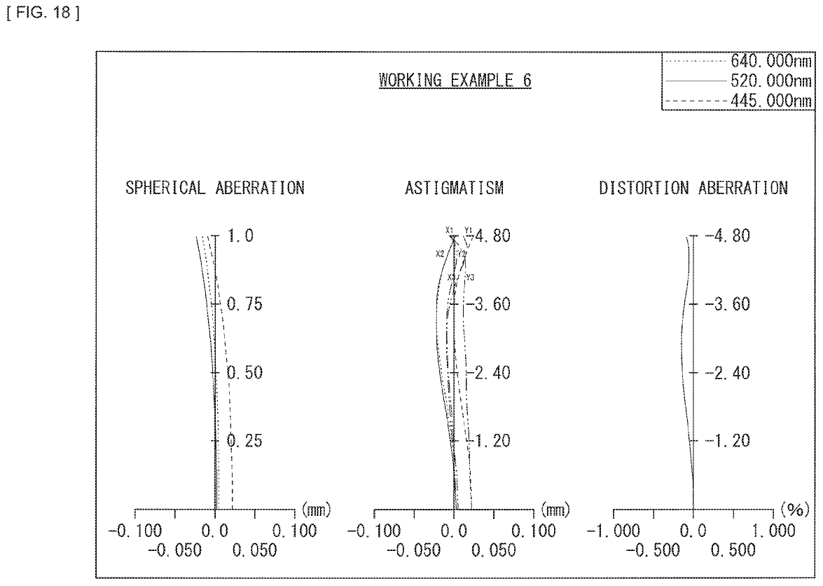

FIG. 18 illustrates various aberrations of the projection lens 6 according to Numerical Working Example 6.

As can be appreciated from each of the aberration diagrams, it is obvious, in Numerical Working Example 6, that the projection lens 6 has favorable optical performance corresponding to a high-pixel display device.

### Numerical Working Example 7

[Table 13] lists basic lens data of Numerical Working Example 7 in which specific numerical values are applied to the projection lens 7. Further, aspherical data are listed in [Table 14].

TABLE 13
Working Example 7 Lens Data

| | Ri | | | |
|---|---|---|---|---|
| Si | Radius of | Di | Ndi | νdi |
| Surface No. | Curvature | Interval | Refractive Index | Abbe Number |
| 1 | 13.624 | 3.000 | 1.583 | 59.5 |
| 2 | 15.039 | 1.937 | — | — |
| 3 | 140.358 | 2.973 | 1.540 | 54.0 |
| 4 | 4.587 | 2.793 | — | — |
| 5 | 38.563 | 4.784 | 1.744 | 44.7 |
| 6 | 18.882 | 1.583 | — | — |
| STO | — | 1.076 | — | — |
| 7 | 16.996 | 5.069 | 1.755 | 27.5 |
| 8 | −17.183 | 4.283 | — | — |
| 9 | −31.821 | 2.386 | 1.847 | 23.8 |
| 10 | 12.420 | 3.276 | 1.497 | 81.6 |
| 11 | −9.986 | 1.000 | — | — |
| 12 | 13.390 | 2.740 | 1.540 | 54.0 |
| 13 | −39.883 | 13.244 | — | — |

TABLE 14
Working Example 7 Aspherical Data

| Si | K | | | |
|---|---|---|---|---|
| Surface | Conic | | | |
| No. | Coefficient | Fourth | Sixth | Eighth |
| 3 | 0.0000E+00 | 5.5480E−04 | −9.3487E−06 | 7.0952E−08 |
| 4 | 0.0000E+00 | 3.4933E−04 | 2.3804E−05 | −3.0254E−06 |
| 12 | 0.0000E+00 | −2.7935E−05 | 1.3194E−06 | 2.5648E−08 |
| 13 | 0.0000E+00 | 6.8549E−05 | 1.2964E−06 | 3.9694E−08 |

| Si | | | |
|---|---|---|---|
| Surface No. | Tenth | Twelfth | Fourteenth |
| 3 | — | — | — |
| 4 | — | — | — |
| 12 | −1.5285E−10 | — | — |
| 13 | −3.5090E−10 | — | — |

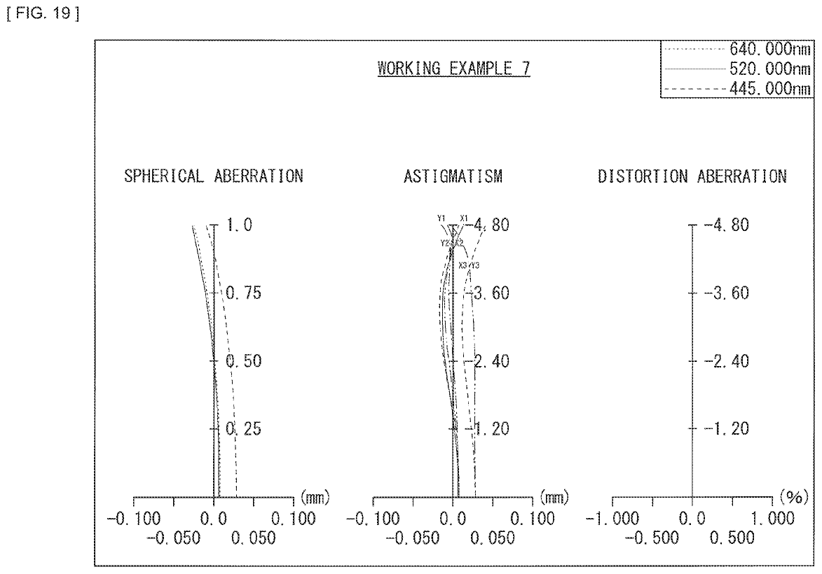

FIG. 19 illustrates various aberrations of the projection lens 7 according to Numerical Working Example 7.

As can be appreciated from each of the aberration diagrams, it is obvious, in Numerical Working Example 7, that the projection lens 7 has favorable optical performance corresponding to a high-pixel display device.

### Numerical Working Example 8

[Table 15] lists basic lens data of Numerical Working Example 8 in which specific numerical values are applied to the projection lens 8. Further, aspherical data are listed in [Table 16].

TABLE 15
Working Example 8 Lens Data

| | Ri | | | |
|---|---|---|---|---|
| Si | Radius of | Di | Ndi | νdi |
| Surface No. | Curvature | Interval | Refractive Index | Abbe Number |
| 1 | 17.960 | 3.042 | 1.497 | 81.6 |
| 2 | −81.949 | 0.874 | — | — |
| 3 | −57.360 | 3.000 | 1.540 | 54.0 |
| 4 | 4.280 | 2.796 | — | — |
| 5 | −24.050 | 4.500 | 1.744 | 44.7 |
| 6 | −65.646 | 1.637 | — | — |
| STO | — | 0.400 | — | — |
| 7 | 19.471 | 5.500 | 1.755 | 27.5 |
| 8 | −13.476 | 4.344 | — | — |
| 9 | −15.400 | 2.400 | 1.847 | 23.8 |
| 10 | 12.035 | 3.246 | 1.594 | 67.0 |
| 11 | −11.613 | 2.742 | — | — |
| 12 | 13.086 | 2.710 | 1.540 | 54.0 |
| 13 | −49.826 | 13.219 | — | — |

TABLE 16
Working Example 8 Aspherical Data

| Si | K | | | |
|---|---|---|---|---|
| Surface | Conic | | | |
| No. | Coefficient | Fourth | Sixth | Eighth |
| 3 | 0.0000E+00 | 4.4394E−04 | −1.4363E−05 | 2.2831E−07 |
| 4 | 0.0000E+00 | 4.8037E−04 | −9.6515E−06 | 5.1594E−07 |
| 12 | 0.0000E+00 | −1.6353E−05 | 2.0259E−06 | −1.3406E−08 |
| 13 | 0.0000E+00 | 9.5330E−05 | 1.7904E−06 | 1.9484E−09 |

| Si | | | |
|---|---|---|---|
| Surface No. | Tenth | Twelfth | Fourteenth |
| 3 | −1.8343E−09 | — | — |
| 4 | −3.3332E−07 | — | — |
| 12 | 1.3552E−09 | −2.7510E−11 | — |
| 13 | 1.3302E−09 | −3.3739E−11 | — |

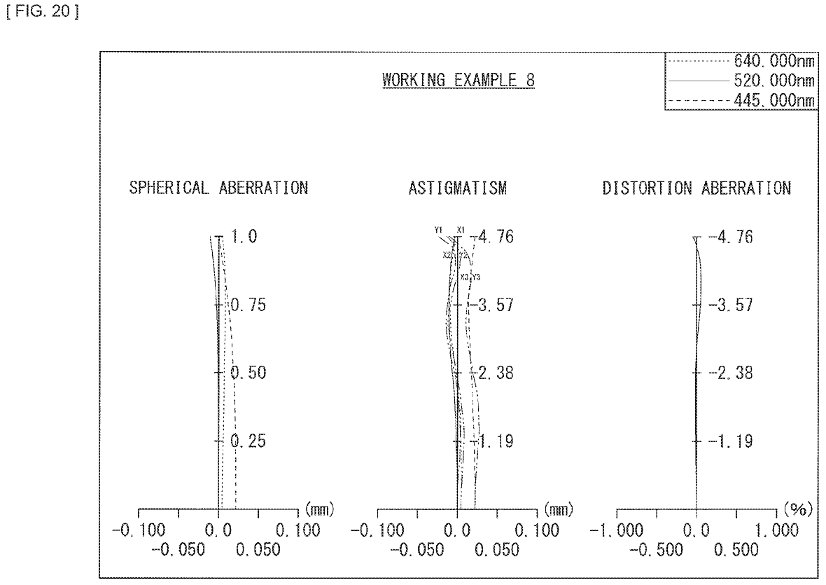

FIG. 20 illustrates various aberrations of the projection lens 8 according to Numerical Working Example 8.

As can be appreciated from each of the aberration diagrams, it is obvious, in Numerical Working Example 8, that the projection lens 8 has favorable optical performance corresponding to a high-pixel display device.

### Numerical Working Example 9

[Table 17] lists basic lens data of Numerical Working Example 9 in which specific numerical values are applied to the projection lens 9. Further, aspherical data are listed in [Table 18].

TABLE 17
Working Example 9 Lens Data

| | Ri | | | |
|---|---|---|---|---|
| Si | Radius of | Di | Ndi | νdi |
| Surface No. | Curvature | Interval | Refractive Index | Abbe Number |
| 1 | 77.177 | 3.000 | 1.826 | 42.88 |
| 2 | −500.068 | 0.663 | — | — |
| 3 | 408.349 | 3.100 | 1.540 | 54.0 |
| 4 | 4.657 | 2.665 | — | — |
| 5 | −26.300 | 4.800 | 1.744 | 44.720 |
| 6 | −78.070 | 2.607 | — | — |
| STO | — | 0.423 | — | — |
| 7 | 22.171 | 5.500 | 1.755 | 27.5 |
| 8 | −19.894 | 5.359 | — | — |
| 9 | −69.507 | 2.400 | 1.847 | 23.8 |
| 10 | 11.825 | 3.110 | 1.497 | 81.6 |
| 11 | −11.839 | 1.000 | — | — |
| 12 | 14.763 | 2.710 | 1.540 | 54.0 |
| 13 | −31.288 | 13.202 | — | — |

TABLE 18
Working Example 9 Aspherical Data

| Si | K | | | |
|---|---|---|---|---|
| Surface | Conic | | | |
| No. | Coefficient | Fourth | Sixth | Eighth |
| 3 | 0.0000E+00 | 4.8943E−04 | −9.1842E−06 | 6.5314E−08 |
| 4 | 0.0000E+00 | 3.9941E−04 | 3.9458E−05 | −3.4934E−06 |
| 12 | 0.0000E+00 | −5.1418E−05 | 1.9223E−06 | 1.8870E−08 |
| 13 | 0.0000E+00 | 2.3261E−05 | 1.5052E−06 | 3.8480E−08 |

| Si | | | |
|---|---|---|---|
| Surface No. | Tenth | Twelfth | Fourteenth |
| 3 | −1.8343E−09 | — | — |
| 4 | −3.3332E−07 | — | — |
| 12 | −1.6905E−10 | — | — |
| 13 | −4.2281E−10 | — | — |

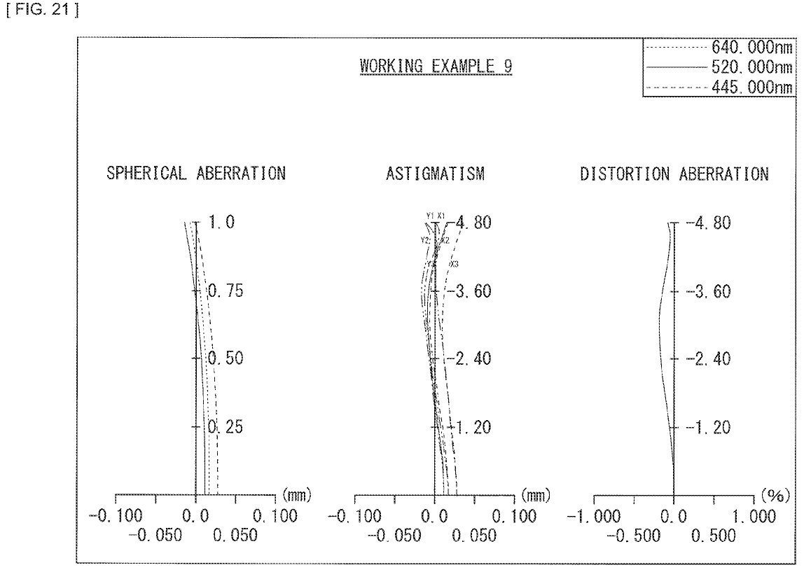

FIG. 21 illustrates various aberrations of the projection lens 9 according to Numerical Working Example 9.

As can be appreciated from each of the aberration diagrams, it is obvious, in Numerical Working Example 9, that the projection lens 9 has favorable optical performance corresponding to a high-pixel display device.

### Numerical Working Example 10

[Table 19] lists basic lens data of Numerical Working Example 10 in which specific numerical values are applied to the projection lens 10. Further, aspherical data are listed in [Table 20].

TABLE 19
Working Example 10 Lens Data

| | Ri | | | |
|---|---|---|---|---|
| Si | Radius of | Di | Ndi | νdi |
| Surface No. | Curvature | Interval | Refractive Index | Abbe Number |
| 1 | 16.300 | 3.000 | 1.806 | 40.9 |
| 2 | 36.805 | 1.458 | — | — |
| 3 | −106.208 | 2.900 | 1.540 | 54.0 |
| 4 | 4.759 | 2.435 | — | — |
| 5 | −21.424 | 4.800 | 1.744 | 44.7 |
| 6 | −48.789 | 2.517 | — | — |
| STO | — | 0.400 | — | — |
| 7 | 18.048 | 5.500 | 1.755 | 27.5 |
| 8 | −25.934 | 3.242 | — | — |
| 9 | −63.179 | 2.400 | 1.921 | 24.0 |
| 10 | 15.186 | 5.878 | 1.497 | 81.6 |
| 11 | −17.433 | 1.459 | — | — |
| 12 | 17.242 | 2.740 | 1.540 | 54.0 |
| 13 | −24.837 | 13.586 | — | — |

TABLE 20
Working Example 10 Aspherical Data

| Si | K | | | |
|---|---|---|---|---|
| Surface | Conic | | | |
| No. | Coefficient | Fourth | Sixth | Eighth |
| 3 | 0.0000E+00 | 4.6409E−04 | −8.1421E−06 | 6.1727E−08 |
| 4 | 0.0000E+00 | 3.2126E−04 | 3.1513E−05 | −2.5354E−06 |
| 12 | 0.0000E+00 | −3.5041E−05 | 2.2199E−06 | 1.9857E−08 |
| 13 | 0.0000E+00 | 8.1879E−05 | 2.1314E−06 | 3.5777E−08 |

| Si | | | |
|---|---|---|---|
| Surface No. | Tenth | Twelfth | Fourteenth |
| 3 | — | — | — |
| 4 | — | — | — |
| 12 | −5.8114E−10 | — | — |
| 13 | −8.3952E−10 | — | — |

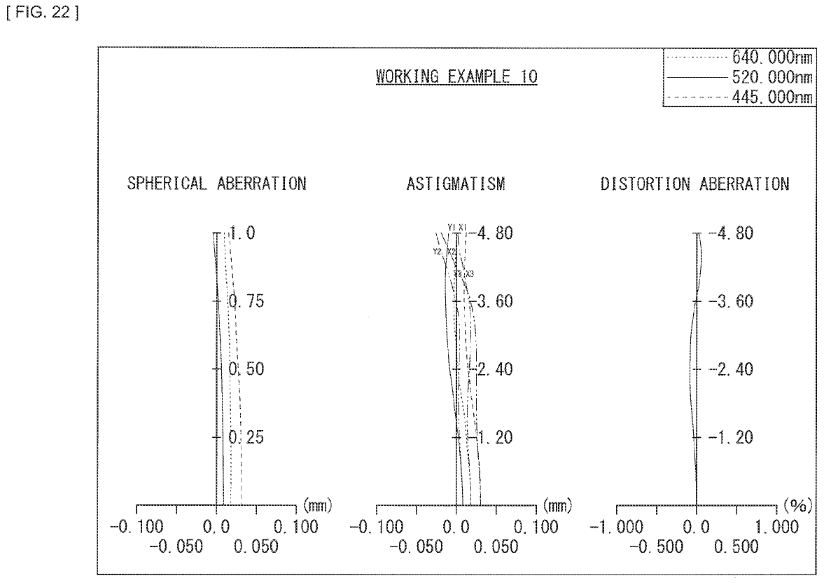

FIG. 22 illustrates various aberrations of the projection lens 10 according to Numerical Working Example 10.

As can be appreciated from each of the aberration diagrams, it is obvious, in Numerical Working Example 10, that the projection lens 10 has favorable optical performance corresponding to a high-pixel display device.

### Numerical Working Example 11

[Table 21] lists basic lens data of Numerical Working Example 11 in which specific numerical values are applied to the projection lens 11. Further, aspherical data are listed in [Table 22].

TABLE 21
Working Example 11 Lens Data

| | Ri | | | |
|---|---|---|---|---|
| Si | Radius of | Di | Ndi | νdi |
| Surface No. | Curvature | Interval | Refractive Index | Abbe Number |
| 1 | 9.513 | 3.287 | 1.806 | 40.9 |
| 2 | 10.402 | 2.376 | — | — |
| 3 | 38.758 | 2.900 | 1.540 | 54.0 |
| 4 | 4.530 | 2.800 | — | — |
| 5 | 48.921 | 4.800 | 1.744 | 44.7 |
| 6 | 21.343 | 1.648 | — | — |
| STO | — | 0.971 | — | — |
| 7 | 20.259 | 5.000 | 1.755 | 27.5 |
| 8 | −12.381 | 1.471 | — | — |
| 9 | −19.738 | 2.400 | 1.847 | 23.8 |
| 10 | 12.784 | 5.378 | 1.497 | 81.6 |
| 11 | −13.291 | 4.000 | — | — |
| 12 | 18.036 | 2.740 | 1.540 | 54.0 |
| 13 | −30.636 | 13.268 | — | — |

TABLE 22
Working Example 11 Aspherical Data

| Si | K | | | |
|---|---|---|---|---|
| Surface | Conic | | | |
| No. | Coefficient | Fourth | Sixth | Eighth |
| 3 | 0.0000E+00 | 4.3936E−04 | −7.0178E−06 | 4.9518E−08 |
| 4 | 0.0000E+00 | 6.0256E−04 | 2.1451E−05 | −1.0706E−06 |
| 12 | 0.0000E+00 | −3.7795E−05 | 1.6125E−06 | 2.0840E−08 |
| 13 | 0.0000E+00 | 5.3711E−05 | 1.8039E−06 | 2.1266E−08 |

| Si | | | |
|---|---|---|---|
| Surface No. | Tenth | Twelfth | Fourteenth |
| 3 | — | — | — |
| 4 | — | — | — |
| 12 | −7.1932E−10 | — | — |
| 13 | −8.0201E−10 | — | — |

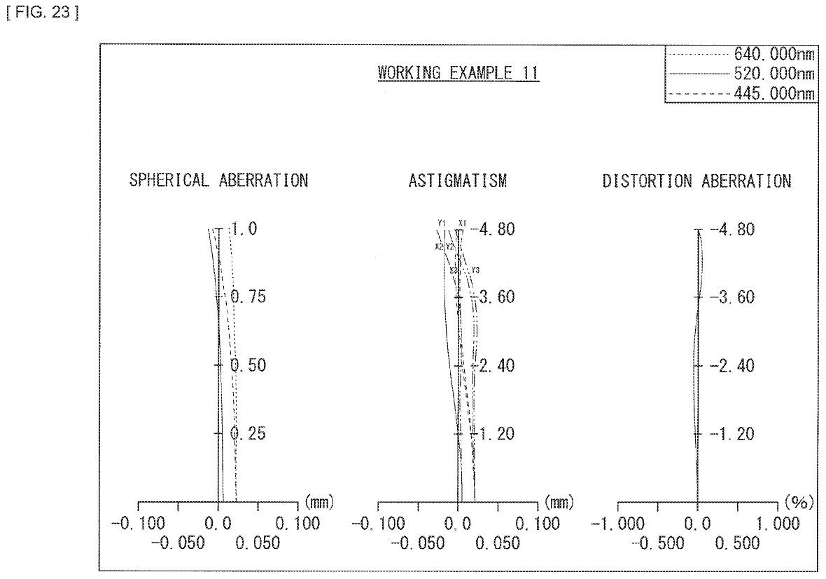

FIG. 23 illustrates various aberrations of the projection lens 11 according to Numerical Working Example 11.

As can be appreciated from each of the aberration diagrams, it is obvious, in Numerical Working Example 11, that the projection lens 11 has favorable optical performance corresponding to a high-pixel display device.

### Numerical Working Example 12

[Table 23] lists basic lens data of Numerical Working Example 12 in which specific numerical values are applied to the projection lens 12. Further, aspherical data are listed in [Table 24].

TABLE 23
Working Example 12 Lens Data

| | Ri | | | |
|---|---|---|---|---|
| Si | Radius of | Di | Ndi | νdi |
| Surface No. | Curvature | Interval | Refractive Index | Abbe Number |
| 1 | 9.526 | 3.465 | 1.806 | 40.9 |
| 2 | 12.488 | 2.067 | — | — |
| 3 | 38.822 | 2.900 | 1.540 | 54.0 |
| 4 | 4.166 | 2.355 | — | — |
| 5 | −520.447 | 4.457 | 1.744 | 44.7 |
| 6 | 44.583 | 1.500 | — | — |
| STO | — | 0.915 | — | — |
| 7 | 18.360 | 5.000 | 1.755 | 27.5 |
| 8 | −10.161 | 0.445 | — | — |
| 9 | −12.223 | 2.400 | 1.847 | 23.8 |
| 10 | 15.219 | 6.000 | 1.497 | 81.6 |
| 11 | −13.634 | 4.000 | — | — |
| 12 | 18.609 | 2.740 | 1.540 | 54.0 |
| 13 | −24.427 | 13.462 | — | — |

TABLE 24
Working Example 12 Aspherical Data

| Si | K | | | |
|---|---|---|---|---|
| Surface | Conic | | | |
| No. | Coefficient | Fourth | Sixth | Eighth |
| 3 | 0.0000E+00 | 4.0029E−04 | −6.3184E−06 | 4.5234E−08 |
| 4 | 0.0000E+00 | 5.1290E−04 | 2.9585E−05 | −1.1397E−06 |
| 12 | 0.0000E+00 | −2.4951E−05 | 2.1128E−06 | 1.7061E−08 |
| 13 | 0.0000E+00 | 9.5807E−05 | 1.9881E−06 | 3.1414E−08 |

| Si | | | |
|---|---|---|---|
| Surface No. | Tenth | Twelfth | Fourteenth |
| 3 | — | — | — |
| 4 | — | — | — |
| 12 | −5.2385E−10 | — | — |
| 13 | −7.4744E−10 | — | — |

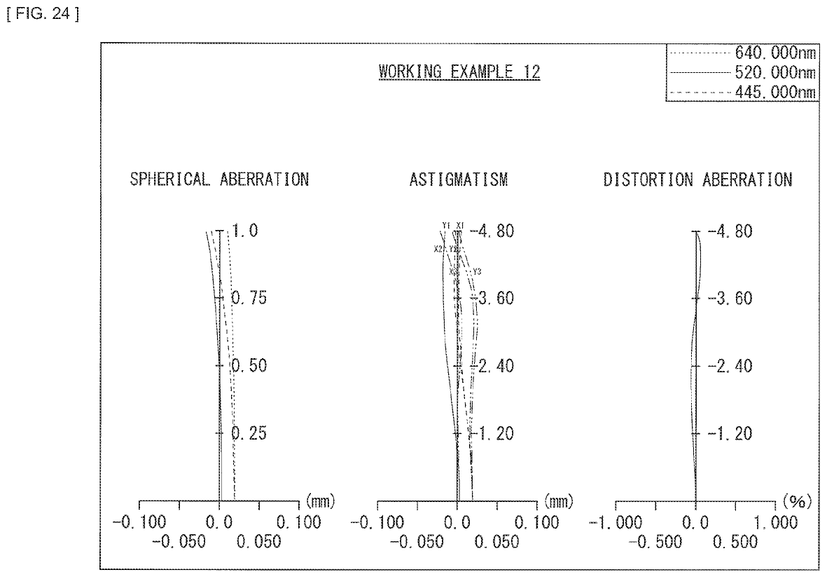

FIG. 24 illustrates various aberrations of the projection lens 12 according to Numerical Working Example 12.

As can be appreciated from each of the aberration diagrams, it is obvious, in Numerical Working Example 12, that the projection lens 12 has favorable optical performance corresponding to a high-pixel display device.

### [Other Numerical Data of Each Working Example]

[Table 25] and [Table 26] summarize values related to the conditional expressions described above for each of the Numerical Working Examples. [Table 27] and [Table 28] summarize parameters used in the conditional expressions described above for each of the Numerical Working Examples. It is to be noted that, in [Table 27], ω·H denotes a half angle of view in a horizontal direction on the projection side. 2ω·H denotes a total angle of view in the horizontal direction on the projection side. As can be appreciated from [Table 25] and [Table 26], the values of each of the Numerical Working Examples fall within the numerical ranges of the respective conditional expressions.

TABLE 25

| | | Working | Working | Working | Working | Working | Working |
|---|---|---|---|---|---|---|---|
| | | Example | Example | Example | Example | Example | Example |
| Conditional Expression | | 1 | 2 | 3 | 4 | 5 | 6 |
| (1) | f/\|fa/fb\| | 18.512 | 20.279 | 21.772 | 24.862 | 21.185 | 20.840 |
| (2) | \|(Nda/fa)/(Ndb/fb)\| | 2.309 | 2.192 | 2.298 | 2.688 | 2.292 | 2.251 |
| (3) | \|(Ra1 + Ra2)/(Ra1 − Ra2))*fa\| | 8.078 | 8.500 | 11.001 | 6.747 | 8.562 | 8.239 |
| (4) | \|(Rb1 + Rb2)/(Rb1 − Rb2))*fb\| | 10.252 | 10.343 | 11.877 | 13.030 | 6.813 | 8.792 |
| (5) | \|(fa/(Ca1 + Ca2)\| | 0.464 | 0.470 | 0.504 | 0.440 | 0.469 | 0.467 |
| (6) | \|(fb/(Cb1 + Cb2)\| | 0.789 | 0.766 | 0.841 | 0.820 | 0.784 | 0.775 |
| (7) | TR | 0.980 | 1.129 | 1.155 | 1.130 | 1.129 | 1.129 |
| (8) | TL/f | 6.351 | 5.591 | 5.690 | 5.483 | 5.596 | 5.526 |
| (9) | f/\|fg1/fg2\| | 5.451 | 5.226 | 5.314 | 5.250 | 4.933 | 5.485 |
| | | Working | Working | Working | Working | Working | Working |
| | | Example | Example | Example | Example | Example | Example |
| Conditional Expression | | 7 | 8 | 9 | 10 | 11 | 12 |
| (1) | f/\|fa/fb\| | 17.050 | 24.834 | 15.699 | 21.473 | 24.768 | 27.509 |
| (2) | \|(Nda/fa)/(Ndb/fb)\| | 2.137 | 2.688 | 2.168 | 2.308 | 2.190 | 2.247 |
| (3) | \|(Ra1 + Ra2)/(Ra1 − Ra2))*fa\| | 9.375 | 6.197 | 8.881 | 7.583 | 12.291 | 10.962 |
| (4) | \|(Rb1 + Rb2)/(Rb1 − Rb2))*fb\| | 9.331 | 11.295 | 6.755 | 3.455 | 5.511 | 2.684 |
| (5) | \|(fa/(Ca1 + Ca2)\| | 0.510 | 0.442 | 0.487 | 0.464 | 0.555 | 0.512 |
| (6) | \|(fb/(Cb1 + Cb2)\| | 0.784 | 0.801 | 0.793 | 0.775 | 0.873 | 0.803 |
| (7) | TR | 0.974 | 1.129 | 0.883 | 1.135 | 1.380 | 1.494 |
| (8) | TL/f | 6.284 | 5.456 | 6.980 | 5.623 | 4.400 | 4.223 |
| (9) | f/\|fg1/fg2\| | 6.057 | 5.674 | 6.101 | 4.596 | 3.491 | 3.060 |

TABLRE 26

| | | Working | Working | Working | Working | Working | Working |
|---|---|---|---|---|---|---|---|
| | | Example | Example | Example | Example | Example | Example |
| Conditional Expression | | 1 | 2 | 3 | 4 | 5 | 6 |
| (10) | vd6-vd5 | 43.220 | 43.220 | 43.050 | 43.220 | 57.820 | 57.820 |
| (11) | \|f1/f2\| | 4.796 | 5.407 | 5.425 | 3.991 | 5.269 | 7.183 |
| (12) | \|f5/f6\| | 0.775 | 0.786 | 0.743 | 0.769 | 0.888 | 0.822 |
| (13) | \|f/f7\| | 0.418 | 0.501 | 0.451 | 0.459 | 0.488 | 0.501 |
| | | Working | Working | Working | Working | Working | Working |
| | | Example | Example | Example | Example | Example | Example |
| Conditional Expression | | 7 | 8 | 9 | 10 | 11 | 12 |
| (10) | vd6-vd5 | 57.820 | 43.220 | 57.820 | 57.650 | 57.650 | 57.650 |
| (11) | \|f1/f2\| | 15.880 | 4.161 | 9.340 | 4.108 | 5.362 | 3.704 |
| (12) | \|f5/f6\| | 0.880 | 0.731 | 0.946 | 0.892 | 0.745 | 0.586 |
| (13) | \|f/f7\| | 0.425 | 0.478 | 0.385 | 0.486 | 0.531 | 0.617 |

TABLE 27

| | Working | Working | Working | Working | Working | Working |
|---|---|---|---|---|---|---|
| | Example 1 | Example 2 | Example 3 | Example 4 | Example 5 | Example 6 |
| f | 8.017 | 9.253 | 9.476 | 9.249 | 9.245 | 9.257 |
| ω · H | 27.031 | 23.891 | 23.409 | 23.871 | 23.891 | 23.893 |
| fg1 | −9.898 | −10.323 | −10.923 | −10.273 | −10.827 | −9.028 |
| fg2 | 13.488 | 13.488 | 14.509 | 13.484 | 13.353 | 12.378 |
| fa | −8.307 | −8.419 | −9.154 | −7.491 | −8.272 | −8.207 |
| fb | 19.182 | 18.452 | 21.032 | 20.137 | 18.956 | 18.476 |
| TL | 50.916 | 51.732 | 53.919 | 50.714 | 51.739 | 51.153 |
| 2ω · H | 54.062 | 47.783 | 46.819 | 47.741 | 47.782 | 47.787 |
| Nda | 1.540 | 1.540 | 1.540 | 1.540 | 1.540 | 1.540 |
| Ndb | 1.540 | 1.540 | 1.540 | 1.540 | 1.540 | 1.540 |
| Ra1 | −328.135 | 950.000 | 48.138 | −83.083 | 255.966 | 2247.331 |
| Ra2 | 4.598 | 4.554 | 4.412 | 4.341 | 4.406 | 4.454 |
| Rb1 | 13.377 | 12.652 | 14.416 | 13.134 | 14.859 | 13.365 |
| Rb2 | −44.087 | −44.929 | −51.816 | −61.294 | −31.534 | −37.636 |
| Ca1 | 5.610 | 5.567 | 5.698 | 5.382 | 5.528 | 5.500 |
| Ca2 | 3.344 | 3.381 | 3.381 | 3.133 | 3.295 | 3.286 |
| Cb1 | 6.109 | 6.057 | 6.283 | 6.180 | 6.070 | 5.997 |
| Cb2 | 6.044 | 5.982 | 6.223 | 6.106 | 6.023 | 5.929 |
| | Working | Working | Working | Working | Working | Working |
| | Example 7 | Example 8 | Example 9 | Example 10 | Example 11 | Example 12 |
| f | 7.980 | 9.240 | 7.240 | 9.304 | 11.308 | 12.243 |
| ω · H | 27.182 | 23.881 | 29.527 | 23.771 | 19.914 | 18.504 |
| fg1 | −7.992 | −9.651 | −8.608 | −11.777 | −12.349 | −15.038 |
| fg2 | 12.102 | 13.690 | 13.130 | 13.532 | 12.679 | 12.437 |
| fa | −8.782 | −7.196 | −8.681 | −8.294 | −9.718 | −8.838 |
| fb | 18.764 | 19.341 | 18.824 | 19.142 | 21.286 | 19.857 |
| TL | 50.144 | 50.410 | 50.538 | 52.315 | 49.751 | 51.707 |
| 2ω · H | 54.365 | 47.763 | 59.053 | 47.543 | 39.827 | 37.008 |
| Nda | 1.540 | 1.540 | 1.540 | 1.540 | 1.540 | 1.540 |
| Ndb | 1.540 | 1.540 | 1.540 | 1.540 | 1.540 | 1.540 |
| Ra1 | 140.358 | −57.360 | 408.349 | −106.208 | 38.758 | 38.822 |
| Ra2 | 4.587 | 4.280 | 4.657 | 4.759 | 4.530 | 4.166 |
| Rb1 | 13.390 | 13.086 | 14.763 | 17.242 | 18.036 | 18.609 |
| Rb2 | −39.883 | −49.826 | −31.288 | −24.837 | −30.636 | −24.427 |
| Ca1 | 5.330 | 5.124 | 5.605 | 5.590 | 5.415 | 5.448 |
| Ca2 | 3.275 | 3.021 | 3.311 | 3.353 | 3.335 | 3.190 |
| Cb1 | 6.018 | 6.073 | 5.950 | 6.191 | 6.109 | 6.201 |
| Cb2 | 5.953 | 5.995 | 5.916 | 6.158 | 6.081 | 6.164 |

TABLE 28

| | Working | Working | Working | Working | Working | Working |
|---|---|---|---|---|---|---|
| | Example 1 | Example 2 | Example 3 | Example 4 | Example 5 | Example 6 |
| vd5 | 23.780 | 23.780 | 23.950 | 23.780 | 23.780 | 23.780 |
| vd6 | 67.000 | 67.000 | 67.000 | 67.000 | 81.600 | 81.600 |
| f1 | 39.838 | 45.523 | 49.665 | 29.898 | 43.586 | 58.947 |
| f2 | −8.307 | −8.419 | −9.154 | −7.491 | −8.272 | −8.207 |
| f5 | −8.647 | −9.003 | −8.133 | −8.239 | −11.259 | −9.569 |
| f6 | 11.153 | 11.455 | 10.943 | 10.718 | 12.680 | 11.643 |
| f7 | 19.182 | 18.452 | 21.032 | 20.137 | 18.956 | 18.476 |
| | Working | Working | Working | Working | Working | Working |
| | Example 7 | Example 8 | Example 9 | Example 10 | Example 11 | Example 12 |
| vd5 | 23.780 | 23.780 | 23.780 | 23.950 | 23.950 | 23.950 |
| vd6 | 81.600 | 67.000 | 81.600 | 81.600 | 81.600 | 81.600 |
| f1 | 139.452 | 29.943 | 81.083 | 34.069 | 52.107 | 32.731 |
| f2 | −8.782 | −7.196 | −8.681 | −8.294 | −9.718 | −8.838 |
| f5 | −10.295 | −7.670 | −11.775 | −13.073 | −8.863 | −7.697 |
| f6 | 11.705 | 10.494 | 12.446 | 14.658 | 11.893 | 13.134 |
| f7 | 18.764 | 19.341 | 18.824 | 19.142 | 21.286 | 19.857 |

### 4. OTHER EMBODIMENTS

The technique of the present disclosure is not limited to the description of the above-described embodiments and the Working Examples, and may be modified and worked in a variety of ways.

For example, shapes and numerical values of the respective parts illustrated in each of the above Numerical Working Examples are each merely one embodying example to work the present technology, and the technical scope of the present technology should not be construed in a limiting fashion by those shapes and numerical values.

In addition, although the description has been given, in the above-described embodiments and Working Examples, of the configuration substantially including seven lenses, a configuration may be employed that further includes a lens having no substantial refractive power.

Moreover, for example, the present technology may have the following configurations.

[1]

A projection lens including, in order from projection side toward side of an image to be projected:

a first lens group including a predetermined negative lens including a material having a linear expansion coefficient equal to or more than 3*10⁻⁵/° C. and having negative refractive power as a whole;

an aperture; and

a second lens group including a predetermined positive lens including a material having a linear expansion coefficient equal to or more than 3*10⁻⁵/° C. and having positive refractive power as a whole.

[2]

The projection lens according to [1], in which the following conditional expression is further satisfied:

12.0<f/|fa/fb|<36.0 (1)

where

f denotes a focal distance of a total lens system in a d-line,

fa denotes a focal distance of the predetermined negative lens in the d-line, and

fb denotes a focal distance of the predetermined positive lens in the d-line.

[3]

The projection lens according to [1] or [2], in which at least one surface of the predetermined negative lens and at least one surface of the predetermined positive lens are each aspherical.

[4]

The projection lens according to any one of [1] to [3], in which the following conditional expression is further satisfied:

1.9<|(Nda/fa)/(Ndb/fb)|<3.0 (2)

where

fa denotes the focal distance of the predetermined negative lens in a d-line,

fb denotes the focal distance of the predetermined positive lens in the d-line,

Nda denotes a refractive index of the predetermined negative lens in the d-line, and

Ndb denotes a refractive index of the predetermined positive lens in the d-line.

[5]

The projection lens according to any one of [1] to [4], in which the following conditional expression is further satisfied:

5.0<|((Ra1+Ra2)/(Ra1 −Ra2))*fa|<14.0 (3)

1.0<|((Rb1+Rb2)/(Rb1−Rb2))*fb|<16.0 (4)

where

fa denotes the focal distance of the predetermined negative lens in the d-line,

fb denotes the focal distance of the predetermined positive lens in the d-line,

Ra1 denotes a radius of curvature of the surface of the predetermined negative lens on the projection side,

Ra2 denotes a radius of curvature of a surface of the predetermined negative lens on the side of the image to be projected,

Rb1 denotes a radius of curvature of a surface of the predetermined positive lens on the projection side, and

Rb2 denotes a radius of curvature of a surface of the predetermined positive lens on the side of the image to be projected.

[6]

The projection lens according to any one of [1] to [5], in which the following conditional expression is further satisfied:

0.35<|(fa/(Ca1+Ca2)|<0.65 (5)

0.65<|(fb/(Cb1+Cb2)|<0.95 (6)

where

fa denotes the focal distance of the predetermined negative lens in the d-line,

fb denotes the focal distance of the predetermined positive lens in the d-line,

Ca1 denotes an effective diameter of a surface of the predetermined negative lens on the projection side in the d-line,

Ca2 denotes an effective diameter of a surface of the predetermined negative lens on the side of the image to be projected in the d-line,

Cb1 denotes an effective diameter of a surface of the predetermined positive lens on the projection side in the d-line, and

Cb2 denotes an effective diameter of a surface of the predetermined positive lens on the side of the image to be projected in the d-line.

[7]

The projection lens according to any one of [1] to [6], in which the following conditional expression is further satisfied:

0.7<TR<1.7 (7)

3.5<TL/f<8.0 (8)

where

TR denotes a projection ratio,

TL denotes a total lens length (air equivalent), and

f denotes the focal distance of the total lens system in the d-line.

[8]

The projection lens according to any one of [1] to [7], in which the following conditional expression is further satisfied:

2.0<f/|fg1/fg2|<7.0 (9)

where

f denotes the focal distance of the total lens system in the d-line,

fg1 denotes a focal distance of the first lens group in the d-line,

fg2 denotes a focal distance of the second lens group in the d-line.

[9]

The projection lens according to any one of [1] to [8], in which

the first lens group includes, in order from the projection side toward the side of the image to be projected,
a first lens having positive refractive power,
a second lens including the predetermined negative lens, and
a third lens, and

the second lens group includes, in order from the projection side toward the side of the image to be projected,
a fourth lens having positive refractive power,
a cemented lens including a fifth lens and a sixth lens and having negative refractive power as a whole, and
a seventh lens including the predetermined positive lens.
   [10]

A projection apparatus including:

a display device that displays an image to be projected; and

a projection lens that projects the image to be projected,

the projection lens including, in order from projection side toward side of the image to be projected,
a first lens group including a predetermined negative lens including a material having a linear expansion coefficient equal to or more than 3*10⁻⁵/° C. and having negative refractive power as a whole,
an aperture, and
a second lens group including a predetermined positive lens including a material having a linear expansion coefficient equal to or more than 3*10⁻⁵/° C. and having positive refractive power as a whole.
   [11]

A projection lens including, in order from projection side toward side of an image to be projected:

a first lens group having negative refractive power as a whole;

an aperture; and

a second lens group having positive refractive power as a whole,

the first lens group including, in order from the projection side toward the side of the image to be projected,
a first lens having positive refractive power,
a second lens having negative refractive power, and
a third lens, and

the second lens group including, in order from the projection side toward the side of the image to be projected,
a fourth lens having positive refractive power,
a cemented lens including a fifth lens and a sixth lens and having negative refractive power as a whole, and
a seventh lens having positive refractive power.
   [12]

The projection lens according to [11], in which the following conditional expression is further satisfied:

2.0<f/|fg1/fg2|<7.0 (9)

where

f denotes a focal distance of a total lens system in a d-line,

fg1 denotes a focal distance of the first lens group in the d-line, and

fg2 denotes a focal distance of the second lens group in the d-line.

[13]

The projection lens according to [11] or [12], in which the following conditional expression is further satisfied:

0.7<TR<1.7 (7)

3.5<TL/f<8.0 (8)

where

TR denotes a projection ratio,

TL denotes a total lens length (air equivalent), and

f denotes the focal distance of the total lens system in the d-line.

[14]

The projection lens according to any one of [11] to [13], in which the following conditional expression is further satisfied:

νd6−νd5>20.0 (10)

where

νd5 denotes Abbe number of the fifth lens in the d-line, and

νd6 denotes Abbe number of the sixth lens in the d-line.

[15]

The projection lens according to any one of [11] to [14], in which the following conditional expression is further satisfied:

3.0<|f1/f2|<18.0 (11)

where

f1 denotes a focal distance of the first lens in the d-line, and

f2 denotes a focal distance of the second lens in the d-line.

[16]

The projection lens according to any one of [11] to [15], in which the following conditional expression is further satisfied:

0.4<|f5/f6|<1.2 (12)

where

f5 denotes a focal distance of the fifth lens in the d-line, and

f6 denotes a focal distance of the sixth lens in the d-line.

[17]

The projection lens according to any one of [11] to [16], in which the following conditional expression is further satisfied:

0.3<|f/f7|<0.8 (13)

where

f denotes the focal distance of the total lens system in the d-line, and

f7 denotes a focal distance of the seventh lens in the d-line.

[18]

A projection apparatus including:

a display device that displays an image to be projected; and

a projection lens that projects the image to be projected,

the projection lens including, in order from projection side toward side of the image to be projected
a first lens group having negative refractive power as a whole,
an aperture, and
a second lens group having positive refractive power as a whole,
the first lens group including, in order from the projection side toward the side of the image to be projected,
   a first lens having positive refractive power,
   a second lens having negative refractive power, and
   a third lens,
the second lens group including, in order from the projection side toward the side of the image to be projected,
   a fourth lens having positive refractive power,
   a cemented lens including a fifth lens and a sixth lens and having negative refractive power as a whole, and
   a seventh lens having positive refractive power.

This application claims the benefit of Japanese priority Patent Application JP2017-056104 filed with the Japan Patent Office on Mar. 22, 2017, the entire contents of which are incorporated herein by reference.

It should be understood by those skilled in the art that various modifications, combinations, sub-combinations, and alterations may occur depending on design requirements and other factors insofar as they are within the scope of the appended claims or the equivalents thereof.

1. A projection lens comprising, in order from projection side toward side of an image to be projected:
a first lens group including a predetermined negative lens including a material having a linear expansion coefficient equal to or more than 3*10⁻⁵/° C. and having negative refractive power as a whole;
an aperture; and
a second lens group including a predetermined positive lens including a material having a linear expansion coefficient equal to or more than 3*10⁻⁵/° C. and having positive refractive power as a whole.

2. The projection lens according to claim 1, wherein the following conditional expression is further satisfied:
12.0<f/|fa/fb|<36.0 (1)
where
f denotes a focal distance of a total lens system in a d-line,
fa denotes a focal distance of the predetermined negative lens in the d-line, and
fb denotes a focal distance of the predetermined positive lens in the d-line.

3. The projection lens according to claim 1, wherein at least one surface of the predetermined negative lens and at least one surface of the predetermined positive lens are each aspherical.

4. The projection lens according to claim 1, wherein the following conditional expression is further satisfied:
1.9<|(Nda/fa)/(Ndb/fb)|<3.0 (2)
where
fa denotes a focal distance of the predetermined negative lens in a d-line,
fb denotes a focal distance of the predetermined positive lens in the d-line,
Nda denotes a refractive index of the predetermined negative lens in the d-line, and
Ndb denotes a refractive index of the predetermined positive lens in the d-line.

5. The projection lens according to claim 1, wherein the following conditional expression is further satisfied:
5.0<|((Ra1+Ra2)/(Ra1−Ra2))*fa|<14.0 (3)
1.0<|((Rb1+Rb2)/(Rb1−Rb2))*fb|<16.0 (4)
where
fa denotes a focal distance of the predetermined negative lens in a d-line,
fb denotes a focal distance of the predetermined positive lens in the d-line,
Ra1 denotes a radius of curvature of a surface of the predetermined negative lens on the projection side,
Ra2 denotes a radius of curvature of a surface of the predetermined negative lens on the side of the image to be projected,
Rb1 denotes a radius of curvature of a surface of the predetermined positive lens on the projection side, and
Rb2 denotes a radius of curvature of a surface of the predetermined positive lens on the side of the image to be projected.

6. The projection lens according to claim 1, wherein the following conditional expression is further satisfied:
0.35<|(fa/(Ca1+Ca2)|<0.65 (5)
0.65<|(fb/(Cb1+Cb2)|<0.95 (6)
where
fa denotes a focal distance of the predetermined negative lens in a d-line,
fb denotes a focal distance of the predetermined positive lens in the d-line,
Ca1 denotes an effective diameter of a surface of the predetermined negative lens on the projection side in the d-line,
Ca2 denotes an effective diameter of a surface of the predetermined negative lens on the side of the image to be projected in the d-line,
Cb1 denotes an effective diameter of a surface of the predetermined positive lens on the projection side in the d-line, and
Cb2 denotes an effective diameter of a surface of the predetermined positive lens on the side of the image to be projected in the d-line.

7. The projection lens according to claim 1, wherein the following conditional expression is further satisfied:
0.7<TR<1.7 (7)
3.5<TL/f<8.0 (8)
where
TR denotes a projection ratio,
TL denotes a total lens length (air equivalent), and
f denotes a focal distance of a total lens system in a d-line.

8. The projection lens according to claim 1, wherein the following conditional expression is further satisfied:
2.0<f/|fg1/fg2|<7.0 (9)
where
f denotes a focal distance of a total lens system in a d-line,
fg1 denotes a focal distance of the first lens group in the d-line,
fg2 denotes a focal distance of the second lens group in the d-line.

9. The projection lens according to claim 1, wherein
the first lens group includes, in order from the projection side toward the side of the image to be projected,
a first lens having positive refractive power,
a second lens including the predetermined negative lens, and
a third lens, and
the second lens group includes, in order from the projection side toward the side of the image to be projected,
a fourth lens having positive refractive power,
a cemented lens including a fifth lens and a sixth lens and having negative refractive power as a whole, and
a seventh lens including the predetermined positive lens.

10. A projection apparatus comprising:
a display device that displays an image to be projected; and
a projection lens that projects the image to be projected,
the projection lens including, in order from projection side toward side of the image to be projected,
a first lens group including a predetermined negative lens including a material having a linear expansion coefficient equal to or more than 3*10⁻⁵/° C. and having negative refractive power as a whole,
an aperture, and
a second lens group including a predetermined positive lens including a material having a linear expansion coefficient equal to or more than 3*10⁻⁵/° C. and having positive refractive power as a whole.

11. A projection lens comprising, in order from projection side toward side of an image to be projected:
a first lens group having negative refractive power as a whole;
an aperture; and
a second lens group having positive refractive power as a whole,
the first lens group including, in order from the projection side toward the side of the image to be projected,
a first lens having positive refractive power,
a second lens having negative refractive power, and
a third lens, and
the second lens group including, in order from the projection side toward the side of the image to be projected,
a fourth lens having positive refractive power,
a cemented lens including a fifth lens and a sixth lens and having negative refractive power as a whole, and
a seventh lens having positive refractive power.

12. The projection lens according to claim 11, wherein the following conditional expression is further satisfied:
2.0<f/|fg1/fg2|<7.0 (9)
where
f denotes a focal distance of a total lens system in a d-line,
fg1 denotes a focal distance of the first lens group in the d-line, and
fg2 denotes a focal distance of the second lens group in the d-line.

13. The projection lens according to claim 11, wherein the following conditional expression is further satisfied:
0.7<TR<1.7 (7)
3.5<TL/f<8.0 (8)
where
TR denotes a projection ratio,
TL denotes a total lens length (air equivalent), and
f denotes a focal distance of a total lens system in a d-line.

14. The projection lens according to claim 11, wherein the following conditional expression is further satisfied:
νd6−νd5>20.0 (10)
where
νd5 denotes Abbe number of the fifth lens in a d-line, and
νd6 denotes Abbe number of the sixth lens in the d-line.

15. The projection lens according to claim 11, wherein the following conditional expression is further satisfied:
3.0<|f1/f2|<18.0 (11)
where
f1 denotes a focal distance of the first lens in a d-line, and
f2 denotes a focal distance of the second lens in the d-line.

16. The projection lens according to claim 11, wherein the following conditional expression is further satisfied:
0.4<|f5/f6|<1.2 (12)
where
f5 denotes a focal distance of the fifth lens in a d-line, and
f6 denotes a focal distance of the sixth lens in the d-line.

17. The projection lens according to claim 11, wherein the following conditional expression is further satisfied:
0.3<|f/f7|<0.8 (13)
where
f denotes a focal distance of a total lens system in a d-line, and
f7 denotes a focal distance of the seventh lens in the d-line.

18. A projection apparatus comprising:
a display device that displays an image to be projected; and
a projection lens that projects the image to be projected,
the projection lens including, in order from projection side toward side of the image to be projected
a first lens group having negative refractive power as a whole,
an aperture, and
a second lens group having positive refractive power as a whole,
the first lens group including, in order from the projection side toward the side of the image to be projected,
a first lens having positive refractive power,
a second lens having negative refractive power, and
a third lens,
the second lens group including, in order from the projection side toward the side of the image to be projected,
a fourth lens having positive refractive power,
a cemented lens including a fifth lens and a sixth lens and having negative refractive power as a whole, and
a seventh lens having positive refractive power.
